(19) United States
(12) Patent Application Publication
(10) Pub. No.: US 2007/0153363 A1
(43) Pub. Date: Jul. 5, 2007

(54) Multilayered device having nanostructured networks

(75) Inventor: George Gruner, Los Angeles, CA (US)

Correspondence Address: VENABLE LLP, P.O. BOX 34385, WASHINGTON, DC, 20043-9998, US

(73) Assignee: Regents of the University of California, Oakland, CA (US)

(21) Appl. No.: 11/581,074

(22) Filed: Oct. 16, 2006

Related U.S. Application Data
(63) Continuation of application No. PCT/US05/47315, filed on Dec. 27, 2005.
(60) Provisional application No. 60/699,013, filed on Jul. 13, 2005.
(60) Provisional application No. 60/639,417, filed on Dec. 27, 2004.

(51) Int. Cl. G02F 1/29

(52) U.S. Cl. 359/315; 977/742

(57) ABSTRACT

An electrode for an electro-optic device according to an embodiment of this invention has a network of carbon nanotubes. The electrode has an electrical conductivity of at least 600 S/cm and a transmittance for 550 nm light of at least 80%. An average thickness of the network of carbon nanotubes is at least 2 nm. A method of producing a device according to an embodiment of this invention includes forming a film of carbon nanotubes on a filter surface by vacuum filtration, pressing a stamp against at least a portion of the film of carbon nanotubes to cause a portion of the film of carbon nanotubes to adhere to the stamp, and pressing the stamp having the portion of carbon nanotubes adhered thereto against a substructure of the device to cause the network of carbon nanotubes to be transferred to a surface of the substructure upon removal of the stamp.

### CROSS-REFERENCE OF RELATED APPLICATION

This application claims priority to U.S. Provisional Application No. 60/639,417 filed Dec. 27, 2004, and U.S. Provisional Application No. 60/699,013 filed Jul. 13, 2005, the entire contents of which are hereby incorporated by reference.

The U.S. Government has a paid-up license in this invention and the right in limited circumstances to require the patent owner to license others on reasonable terms as provided for by the terms of NSF Grant No. 0404029.

### BACKGROUND

1. Field of Invention

This application relates to electronic and/or electro-optic components formed from nano-scale materials, devices made with these components, and methods of production.

2. Discussion of Related Art

The contents of all references, including articles, published patent applications and patents referred to herein are hereby incorporated by reference.

Nanostructures or nano-scale materials are three-dimensional structures where at least one dimension is less than 100 nm. The term “nano-structure” includes nanoparticles, nanowires, nanofibers, nanoribbons, nanoplates and nanotubes. The term nanotube is sometimes abbreviated “NT” herein.

It has been shown that carbon nanotube networks can be used as an electronic material, by having a finite electrical conduction. Resistors have been fabricated by such networks and it has been shown (L. Hu et al Nano letters 4, (2004)) that such networks are also flexible and transparent. Networks of nanotubes have also been shown to support Field Effect Transistor (FET) operation. (Snow, E. S., Novak, J. P., Campbell, P. M. & Park, D. “Random Networks of Carbon Nanotubes as an Electronic Material”, Applied Physics Letters, 82, 2145-2147 (2003); J-C Gabriel, “Large Scale Production of Carbon Nanotube Transistors, “Mat. Res. Soc. Symp. Proc., 776 K. Bradley, J-C P Gabriel and G. Gruner,”πFlexible Nanotube Electronics” Nano Lett., 3, 1353 (2003); N. P. Armitage, C P Gabriel and G. Gruner, “Langmuir-Blodgett Nanotube Films”, J. Appl. Phys. Lett, 95, 6, 3228-3330 (2003)).

Other nanowires or nanofibers have also been shown to act as an electronic material and have been incorporated into various devices. Transistors have also been fabricated using nanofiber networks. Nanoelectronic Devices Based On Nanowire Networks Richard Kaner, Jason Huang George Gruner see PCT/USO4/28633.

In order to support electrical conduction the network has to be above the so called percolation threshold where at least one interconnected path through the elements provides a conducting channel between the two electrodes, and the properties of the network depend on the density L. Hu et al Nano Letters 4 (2004).

The nano-structure networks are also often “functionalized”. Functionalization means a change of the nano-structured material properties, such as the electron or hole concentration or the mobility. Such functionalization may be achieved by attaching chemicals to the nano-structured materials. As an example, the conductivity can be enhanced by attaching molecules to the nanotubes. The effect of such attachment is twofold:
1. Changing the carrier number. i.e. the electron or hole concentration, potentially increasing the number of carriers, and
2. Changing—predominantly decreasing—the mobility through the potential created by the attached molecule.

As a rule, relatively strong binding to the nanotubes is required in order to create a stable structure so that the molecules are not removed by a liquid, mechanical effects and the like. Such strong binding however also leads to a strong potential that decreases the mobility. Doping has been performed (B. Ruzicka et al Phys. Rev. B61, R2468 (2000).

Networks that have been functionalized are air sensitive and have to be kept in an agent-rich environment (B. Ruzicka et al Phys. Rev. B61, R2468 (2000).

The current invention also includes nano-scale material networks that have been functionalized also with a chemical that leads to a specific property (such as sensitivity to light, and biomaterials) in addition to the agents that lead to electron or hole doping as discussed above. Functionalizations have also been described in the patent Room Temperature Deposition Of Nanotube Transistor Networks (PCTUSO5/03822).

### SUMMARY

Further objectives and advantages will become apparent from a consideration of the description, drawings, and examples.

An electrode for an electro-optic device according to an embodiment of this invention has a network of carbon nanotubes. The electrode has an electrical conductivity of at least 600 S/cm and a transmittance for 550 nm light of at least 80%. An average thickness of the network of carbon nanotubes is at least 2 nm.

An electro-optic device according to an embodiment of this invention has an at least semi-transparent electrode that has a network of carbon nanotubes. The network of carbon nanotubes has an electrical conductivity of at least 600 S/cm and a transmittance for 550 nm light of at least 80%. An average thickness of the network of carbon nanotubes is at least 2 nm.

A method of producing a device according to an embodiment of this invention includes forming a film of carbon nanotubes on a filter surface by vacuum filtration, pressing a stamp against at least a portion of the film of carbon nanotubes to cause a portion of the film of carbon nanotubes to adhere to the stamp, and pressing the stamp having the portion of carbon nanotubes adhered thereto against a substructure of the device to cause the network of carbon nanotubes to be transferred to a surface of the substructure upon removal of the stamp.

A conductive nanotube network according to an embodiment of this invention has a plurality of carbon nanotubes that have an average length that is greater than 5 μm. The conductive nanotube network also has a conductivity of at least 4000 S/cm.

An electrode for an electro-optic device according to an embodiment of this invention has a plurality of metallic carbon nanotubes and a plurality of semiconducting carbon nanotubes. A ratio of a number of the plurality of metallic carbon nanotubes to a number of the plurality of semiconducting carbon nanotubes is greater than 0.4, thereby providing the electrode with an enhanced electrical conductivity compared to electrodes having a ratio of about 0.3 metallic carbon nanotubes to semiconducting carbon nanotubes.

A method of producing a device according to an embodiment of this invention includes providing a substructure of the device, producing a carbon nanotube network separate from the substructure of the device; and transferring the carbon nanotube network to a surface of the substructure of the device.

A device according to an embodiment of this invention has a substructure that is at least one of an electrically active and an optically active substructure, and a nanostructured network layer disposed on the substructure of the device. The nanostructured network has nanotubes and at least one of nanoparticles, nanoribbons, nanowires, and nanoplates.

In addition, devices according to embodiments of this invention are manufactured according to the methods of this invention.

### BRIEF DESCRIPTION OF THE DRAWINGS

The invention is better understood by reading the following detailed description with reference to the accompanying figures in which:

FIG. 1 shows sheet conductance versus volume of solution to illustrate some concepts of this invention;

FIG. 2 shows sheet conductance versus coverage density;

FIG. 3 shows optical transmittance at 550 nm versus nanotube coverage;

FIG. 4 is a schematic illustration to facilitate an explanation of functionalizing nanotube networks;

FIG. 5 shows sheet conductance versus nanotube density with the sheet conductance of all-metallic tabs indicated;

FIG. 6 shows optical transmittance at 550 nm versus nanotube network density with the full line representing theory;

FIG. 7 shows dependence of source-drain current on a back-gate transistor device with a spin-coated nanotube network;

FIG. 8 shows dependence of source-drain current on the source-drain voltage of a transistor with a nanotube network conducting channel;

FIG. 9 shows the sheet resistance as a function of nanotube amount deposited on the surface;

FIG. 10 is a schematic illustration of a stamp method of production according to an embodiment of the current invention;

FIG. 11 is a series of photographs showing patterned nanotube films on a PET substrate;

FIG. 12 shows the sheet resistance versus transmittance for nanotube films produced according to an embodiment of the current invention;

FIG. 13 shows the optical parameters n and k of carbon nanotube networks;

FIG. 14 shows the optical transmission, reflection and absorption of a nanotube film according to an embodiment of the current invention;

FIG. 15 shows the optical transmission and reflection of an ITO film in the visible range;

FIG. 16 shows sheet resistance versus transmittance for nanotube networks according to an embodiment of the current invention;

FIG. 16A is a table of measured data corresponding to the cases of FIG. 12;

FIG. 17 is a graph to help summarize limitations of the prior art;

FIG. 18 is a schematic illustration of an interpenetrating nano-scale network according to an embodiment of the current invention;

FIG. 19 is a schematic illustration of an interpenetrating nano-scale network according to another embodiment of the current invention;

FIG. 20 is a schematic illustration of an interpenetrating nano-scale network according to another embodiment of the current invention;

FIG. 21 is a schematic illustration of an interpenetrating nano-scale network according to another embodiment of the current invention;

FIG. 22 is a schematic illustration of an interpenetrating nano-scale network according to another embodiment of the current invention;

FIG. 23 is a schematic illustration of an interpenetrating nano-scale network according to another embodiment of the current invention;

FIG. 24 is a schematic illustration of an interpenetrating nano-scale network according to another embodiment of the current invention;

FIG. 25 is an AFM image of a gold nanoparticle-carbon nanotube network according to an embodiment of the current invention;

FIG. 26 shows 2.2 nm diameter gold nanoparticles (NP) on silicon wafer by incubation;

FIG. 27 is a schematic illustration of a solar cell structure according to an embodiment of the current invention;

FIG. 28 shows a nanoscale polyaniline network according to an embodiment of the current invention;

FIG. 29 shows TEM images of a nanostructure according to an embodiment of the current invention;

FIG. 30 shows a nanotube-fabric composite structure according to an embodiment of the current invention;

FIG. 31 is a schematic illustration of a smart window according to an embodiment of the current invention;

FIG. 32 is a schematic illustration of a solar cell according to an embodiment of the current invention;

FIG. 33 is a schematic illustration of a light emitting diode according to an embodiment of the current invention;

FIG. 34 is a schematic illustration of a nanowire-nanoparticle network according to an embodiment of the current invention;

FIG. 35 is a schematic illustration of a transistor according to an embodiment of the current invention;

FIG. 36 is a schematic illustration of a transistor according to another embodiment of the current invention;

FIG. 37 is a schematic illustration of a transistor according to another embodiment of the current invention;

FIG. 38 illustrates features of a smart window according to an embodiment of the current invention;

FIG. 39 illustrates features of an electro-chromic device according to an embodiment of the current invention;

FIG. 40 illustrates features of an electro-chromic device according to an embodiment of the current invention;

FIG. 41 shows AFM images of nanotube networks according to embodiments of the current invention;

FIG. 42 shows optical and SEM images of a sprayed nanotube fabric according to an embodiment of the current invention;

FIG. 43 shows a conducting fabric according to an embodiment of the current invention;

FIG. 44 is a table of conductivities of various materials on both flat and rough surfaces according to embodiments of the current invention; and

FIG. 45 shows frequency dependence of conductivity of fabric according to an embodiment of the current invention.

### DETAILED DESCRIPTION

In describing embodiments of the present invention illustrated in the drawings, specific terminology is employed for the sake of clarity. However, the invention is not intended to be limited to the specific terminology so selected. It is to be understood that each specific element includes all technical equivalents which operate in a similar manner to accomplish a similar purpose.

The term “electro-optic” device has a broad definition herein that includes any device that has desirable electrical and optical properties. Electro-optic devices include, but are not limited to solar cells, solid state lighting devices, touch screens, display devices, smart windows, defrosting windows, electromagnetic screens, and static screens.

The term “electrode” has a broad definition herein that includes any component that is intended to conduct a charged current. The electrodes for electro-optic devices herein may be further defined to have certain optical properties in addition to electrical properties in some, but not necessarily all applications.

The Relationships Between Conductivity Sheet Conductance and Optical Transparency

The nanotube density of the nanotube network on a surface can be described by either:
average network thickness, d
nanotube surface density, sd or nanotube coverage c of the surface that supports the network

100% coverage of a network leads to an average thickness equivalent to the diameter of the nanotubes, this also corresponds to a surface density of 100%. Networks with more or less than 100% coverage can be fabricated and are included in this invention.

The dc, direct current conductivity σ_{do} is a parameter that is independent of the nanotube density. The sheet conductance, the technically important parameter is given by σ_{dc}d. Various factors determine the dc conductivity:
number of charge carriers (electrons or holes)
number of NT-NT interconnects per unit area
NT-NT interconnect resistance
fraction of metallic tubes to non-metallic, such as semiconducting tubes

The equation below describes the transparency T, or transmittance—the transmitted to power of the electromagnetic radiation through a film assuming that the film thickness is much less than the wavelength and also assuming that the imaginary part of the conductivity can be neglected (M. Dressel and G. Gruner: Electrodynamics of Solids, Cambridge University Press 2002):

$$T = \frac{1}{{( 1 + \frac{2 π}{c} {σ}_{ac} d )}^{2}} \qquad ( 1 )$$

Here σ_{ac} is the optical conductivity, and c the speed of light, d is the film thickness as defined above and is proportional to the nanotube network surface density. It has been shown that the ac conductivity in the visible spectral range, or in the range where the sunlight has substantial intensity is largely proportional to the density of the nanotube network, but is not, or is only very weakly influenced by inter-tube resistances, and by the nanotube length, and in addition it is not strongly influenced by doping.

### EMBODIMENTS OF THE INVENTION

Carbon nanotube networks are a random array of nanotubes, usually on a substrate. The surface coverage by the network can be less than one monolayer, i.e. full coverage, but can be more. Due to the conducting properties of the nanotubes, the network is an electrically conducting medium above a certain nanotube density. Networks fabricated to date do not exceed a dc conductivity of 1000 Siemens/cm, yet many important applications require 4000 Siemens/cm.

Transparency in the visible and ultraviolet spectral range is determined largely by nanotube coverage, with more coverage leading to less transparency (see Eq. 1). In the infrared range, additional factors, such as the carrier density, are also important. Full coverage with one monolayer of nanotubes yields approximately 80% transparency.

The dc, direct current conductivity is determined and/or influenced by:
1. the number of charge carriers (electrons or holes);
2. the number of nanotube-nanotube interconnects per unit surface area;
3. the nanotube-nanotube interconnect resistance; and
4. the proportions of metallic nanotubes and of semiconducting nanotubes in the network.

Many applications require high transparency and high, so-called, sheet conductance. These include transparent electrodes for solar cells, transparent displays, touch screens, electromagnetic shielding, smart windows, transparent coating for heated windows, light emitting diodes, transistors and coatings for fabrics among others. The sheet conductance is defined as the conductivity of a square (the length of the layer the same as the width) of the network layer. (The sheet resistance is the inverse of the sheet conductance).

An embodiment of the current invention provides highly conductive nanotube networks having a dc conductivity of at least about 4000 Siemens/cm and methods of fabricating these together with the ink material that is used for the fabrication. Highly conductive nanotube networks, exceeding the conductivity of networks that have been fabricated to date can be obtained by:
1. increasing the number of charge carriers by doping;
2. reducing the number of nanotube-nanotube interconnects per unit area by using long nanotubes;
3. reducing the nanotube-nanotube interconnect resistance by doping or coating the network;
4. increasing the proportion of metallic nanotubes in the network; and
5. combinations of the above.

Two parameters, the carrier density and the carrier mobility determine the electrical conductivity of the nanotube networks. The conductivity, together with the nanotube density, in turn determines the two technical parameters: sheet conductance and optical transparency. Applications for transparent electronics require that the sheet resistance, the inverse of the sheet conductance, is sufficiently small, and an optical transparency is sufficiently high. For example, for indium-tin-oxide, 90% transparency and 100 Ohms/square sheet resistance are the typical values. Nanotube networks fabricated to date, while both conducting and transparent, have not been able to achieve the right combination of sheet conductance and transparency to be competitive with currently used materials such as indium-tin-oxide (ITO).

A comparison between typical nanotube network parameters and parameters that characterize the properties of ITO are given below.

Sheet Conductance or Sheet Resistance of Indium-Tin-Oxide at 90% Transparency

Higher sheet conductance leads to superior device performance, or leads to higher transparency if films with the same sheet conductance are made. Touch screen/Display applications require 200×10⁻⁵ Siemens/square at 90% transparency. Sheet Resistance (inverse sheet conductance), current technology (approximate values) for 90% transparency:

| | |
|---|---|
| ITO single crystal | 100 Ohms/square |
| ITO commercial | 300 Ohms/sauare |
| Nanotube networks (L. Hu et al Nano | |
| Letters 4, 2513 (2004)) | |
| NT network (undoped, commercial NT) | 1000 Ohms/square |

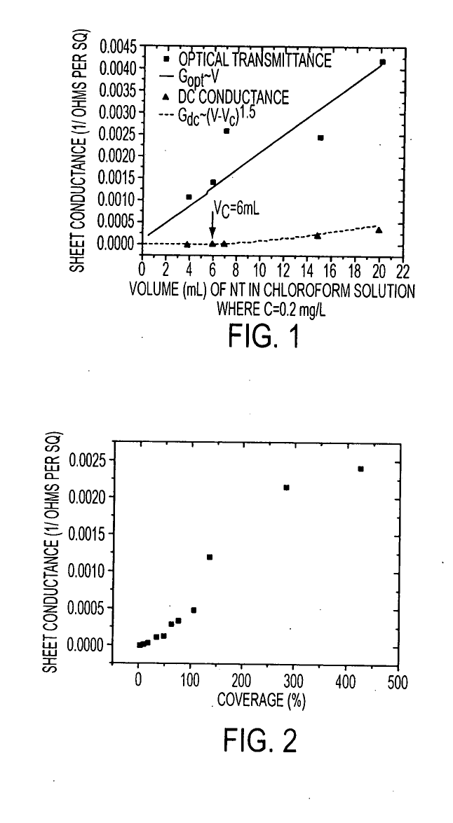

The sheet conductance and the optical transparency of the carbon nanotube network depends, for a particular nanotube deposition method, and starting material, on the nanotube surface density. FIGS. 1 and 2 illustrates such a relation (L. Hu et al Nano Letters 4, 2513 (2004)).

Sheet Conductance can also be expressed as the function of Surface Coverage for carbon nanotube networks.

Surface Coverage is a parameter proportional to the nanotube network density, and is also proportional to the volume density of the nanotubes in solution, if the network density is fabricated using a method of deposition form solution. This latter relation has been established through imaging as follows:
Surface Coverage=(Volume of NT solution/7 mL)×10%

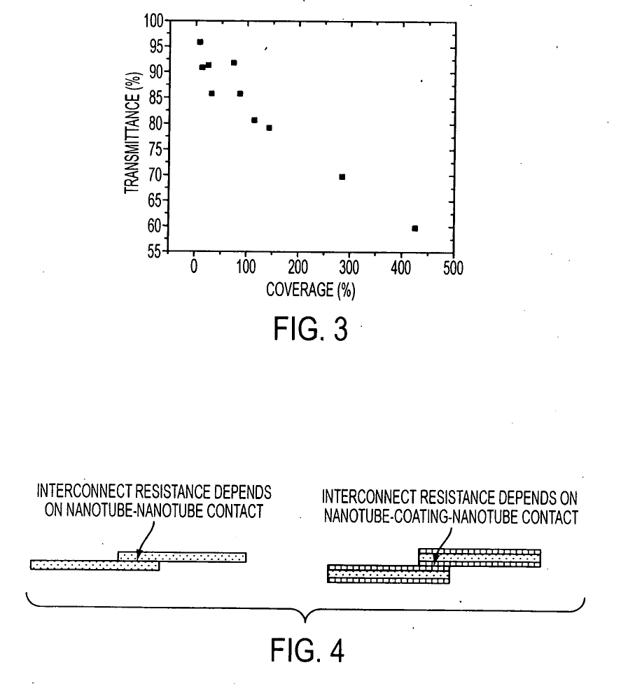

A plot of Transmittance as a function of Surface Coverage for carbon nanotube networks and light with a wavelength of 550 nm is shown in FIG. 3.

High dc conductivity σ_{dc} allows the fabrication of networks with high dc current sheet conductance σ_{dc} d, (where d is the thickness of the network, this thickness is proportional to the density of a nanotube network). Full, or 100% coverage of single wall nanotubes refers to a thickness d equivalent of the diameter of the tubes. For coverage less than 100%, the “thickness” d is defined as the percentage coverage, multiplied by the diameter of the tubes. The dc conductivity is determined mainly by the:
1. number of charge carriers (electrons or holes) in the nanotubes;
2. number of nanotube-nanotube interconnects per unit area;
3. nanotube-nanotube interconnect resistance; and
4. fraction of the metallic tubes that form the network.

It has been shown that the ac conductivity in the visible spectral range, the parameter that (together with the nanotube density) determines the optical transparency, is not, or is only very weakly, influenced by inter-tube resistance, and by the nanotube length. In addition, it is not strongly influenced by doping:

Embodiments of the invention include a carbon nanotube network structure and also a fabrication of the network, for which the dc electrical conductivity exceeds a value of 4000 (Siemens/cm).

Networks Of Long Nanotubes.

The dc conductance of carbon nanotube networks is limited by the inter-tube resistance which is approximately 100 MOhms, about 4 orders of magnitude larger than the resistance of the carbon nanotubes themselves, which is 10 kOhms.

Reducing the inter-tube resistance per unit area can lead to increased dc conductivity. The resistance can be reduced by reducing the number of nanotube-nanotube interconnects per unit area of the network. Assume that we increase the length scale of a network by a factor X by fabricating a network with the equivalent geometry but using nanotubes twice the length l, in a fashion that is similar to a magnification with a copying machine. As the sheet resistance depends on the number of interconnects, both the sheet resistance and the sheet conductance are unchanged. However the nanotube density has decreased by a factor of X². As the optical conductivity is largely proportional to the nanotube density, the optical conductivity is decreased by a factor of X² and through Equation (1) the transparency is increased.

A similar conclusion can be reached by the expression of the so-called percolation threshold, again connecting the nanotube length to the number of interconnects. For a model that assumes that the network is composed of rods of length l, the number of nanotube-nanotube interconnects per unit area is given by:
l\sqrt{πN_{c}}==4.236 (2)
and the same relation holds for various densities above the percolation threshold. Because the sheet resistance is inversely proportional to X² (or equivalently the conductivity, for the same film thickness is proportional to X²) and an increase of, for example, a factor of 3, in nanotube length leads to a decrease of a factor of 9 in the sheet resistance, and an increase of the dc conductivity σ_{dc}, by the same factor of 9.

Nanotube networks reported in the paper by Lu (2004), and reported by others are made from nanotubes with lengths of approximately 1 micron. The dc conductivities measured from these networks have been 2000 Siemens/cm or less and are not acceptable for most applications.

In one embodiment of the invention, nanotube networks are made from nanotubes that have, on average, lengths of at least about 5 μm and have dc conductivities of at least approximately 3000 Siemens/cm. In another arrangement, nanotube networks are made from nanotubes that have, on average, lengths of at least about 6 μm and have dc conductivities of at least approximately 5000 Siemens/cm.

Increasing Conductivities Of Nanotubes In Networks

Carbon nanotubes can be modified chemically (functionalized), leading to changes of the electronic structure, and bonding properties to the surroundings. Functionalization refers to a chemical procedure that leads to changes of the nanotube electronic properties, or the resistance associated with the interconnects between nanotubes. Functionalization can also be referred to as doping. Such doping can be performed by dissolving the nanotubes in a solution and performing the functionalization in a wet chemistry environment. Several modifications can be made, and observed by optical and chemical methods.

In some embodiments of the invention, functionalization of various types is used to increase conductivities of the individual nanotubes. Functionalization involves treating nanotubes with chemical species either during or subsequent to nanotube growth. Examples of functionalization types include:

Those that lead to a charge transfer between the functionalization molecule or layer of molecules and the nanotubes (hole or electron donation).

Exemplary Hole Donors:
Organic compounds, such as TCNQ (Tetracyanoquinodimethane) and TCNE (Tetracyanoethylene)
Inorganic species, such Br (bromine), Cl (chlorine), I (iodine), SOCl₂ (thionyl chloride), SO₃, (sulphur trioxide), NO₂ (nitrogen dioxide), NOBF₄ (nitrododium tetrafluoroborate), and NO₂BF₄ (nitronium tetrafluoroborate).

Electron Donors:

Strong electron donation leads to increased conductivity due to electrons, in particular if de-oxygenation, which can remove the p-doping of nanotubes, also occurs. Thus the combination of the two—electron doping and partial oxygen removal can cause increased electron conductivity of the individual nanotubes and therefore of the whole network. One example of a functionalization that increases electron conductivity in carbon nanotubes is a coating of the polymer PEI (polyethylene-imine).

In some embodiments, doping or functionalizing nanotubes can also affect their optical conductivity. In one arrangement, doping with iodine does not have an observable effect on the ac optical conductivity in the visible spectral range, while at the same time, significantly increases the dc conductivity.

Nanotube Network Functionalization for Decreased Inter-Tube Resistance

In some embodiments, modifications are made to nanotube networks, which provide improved current flow, or increased nanotube-nanotube junction conductance (decreased resistance) from one nanotube to the other, through:
Doping with chemical species with at least partially conducting properties
Doping with semiconducting polymers
Doping with metal nanoparticles

In all cases above current flows from nanotube, to functionalization agent, which may coat or partially coat the nanotubes, to nanotube, circumventing the larger nanotube-nanotube junction resistance. FIG. 4 is a schematic illustration that illustrates some of these effects.

Networks Fabricated Using an Enhanced Fraction of Nanotubes with Metallic Characteristics

In another embodiment or the invention, significantly increased network conductivity is achieved by increasing the fraction of metallic nanotubes in the nanotube networks. The nanotubes can be made of any material known to form nanotubes that have metallic conduction characteristics.

Currently known nanotube networks contain both metallic and semiconducting nanotubes. In currently produced networks, approximately ⅔ of carbon nanotubes are semiconducting and ⅓ are metallic. The metallic nanotubes have a conductivity approximately one order of magnitude higher than the semiconducting nanotubes. Consequently, networks with a larger proportion of metallic nanotubes have higher conductivities. This can be confirmed by the FET transistor behavior of the devices, indicating an “on” current at least one order of magnitude higher than the correct at zero voltage.

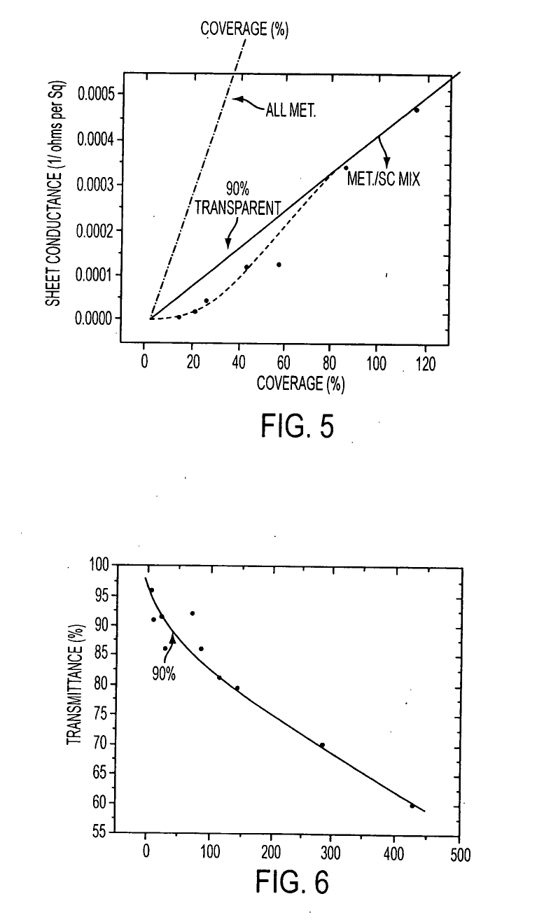

The increase of the conductivity expected as a function of the increase of the fraction of metallic carbon nanotubes can be estimated as follows. For high densities (well above the percolation threshold), where the conductivity is proportional to the nanotube density, the conductivity will be proportional to the total number of metallic and semiconducting tubes, and this is indicated on the dash-dotted line in FIG. 5. For a mixture of semiconducting and metallic tubes, at 90% transparency (see FIG. 6), the network is close to the percolation threshold and such linear behaviour does not apply. The ratio of the two conductivities at densities corresponding to 90% transparency, approximately a factor of 9 (see FIG. 5) is the ratio of the conductivity of “as produced” to 100% metallic tubes. With a linear extrapolation, an enrichment from ⅓ to ⅔ leads to an enhancement of the conductivity of a factor of 4. Similar calculations can be performed, by using FIG. 5 and a linear extrapolation as above to arrive at an enhancement for other metallic/semiconducting ratios and for other transparencies.

Combinations of the Above

In some embodiments, a conductance of 4000 Siemens/cm in a nanotube network is achieved by using at least some of the above embodiments (e.g., increased nanotube length, enhanced fraction of metallic nanotubes, functionalization to increase nanotube conductivity, and functionalization to reduce nanotube-nanotube interconnect resistance) in combination.

Nanotube Network Fabrication Methods

There are several methods for fabricating nanotube films using nanotubes grown by a variety of methods. The fabrication methods include chemical vapor deposition (CVD), drop casting/spraying from solvents, spin coating. Quasi-Langmuir-Blodgett deposition, dip-casting, and printing methods.

One embodiment of the invention includes methods for fabrication of nanotube networks. In one arrangement, functionalization is performed in a solvent prior to deposition of the nanotubes onto the desired substrate. In another arrangement, functionalization is performed after deposition of the nanotubes onto the desired substrate. Several fabrication methods are included in the embodiments of the current invention. Examples of fabrication methods include:

1. Spray painting

1.a. The following steps summarize the fabrication.
   Solubilization of the nanotubes in an appropriate solution Deposition of the solvent containing the nanotubes onto a surface to form a network
   Functionalization of the deposited network
1.b. Solubilization of the nanotubes in an appropriate solution that includes the functionalization agent
   Deposition of the solution onto a substrate to form a network. Such method is also suitable for deposition of a patterned network with varying network density onto a surface.
      2. Spin Coating
2. a. Solubilization of the nanotubes in an appropriate solution Deposition of the nanotubes onto a surface to form a network Functionalization
2.b. Solubilization of the nanotubes in an appropriate solution that includes the functionalization agent
   Deposition of the solution onto a substrate to form a network
      3. Deposition Through Nanotube Network Transfer from One Layer to Another
3. a Solubilization of the nanotubes in an appropriate solution Deposition of the nanotubes onto a substrate to form a network coating the nanotube network and substrate with a thin layer removing the nanotube network and the thin layer together from the substrate
3.b. Deposition of the functionalized network on a substrate application of the solubilization agent
   coating with a thin layer
   removing the nanotube network and the thin layer together from the substrate

4. Dip-Pen Lithography

The nanotube network is deposited through a printing method similar to ink-jet or dip-pen deposition using commercial deposition instruments. Such methods are also suitable for depositing patterned networks, with varying density, onto a surface.

The substrate can be a porous material, such as alumina, or a material such as Si or Si oxide that has been treated for improved attachment of the nanotubes to the surface. Other possible substrates include glass (e.g., organosilicate glass), polymers (e.g., parylene, PET, fluoropolymers) antireflection materials, low dielectric constant materials (e.g., porous low k materials).

Methods for Chemical Functionalization for Enhanced Sheet Conductance

### EXAMPLE 1

Functionalize the Nanotubes in Solution, Deposit Subsequently

To test the effects of chemical doping on the sheet resistance of the nanotube networks, first several nanotube network samples were prepared by sonicating HpCO tubes in Chloroform and depositing them on an alumina filter membrane. Two different samples, with the following characteristics were prepared:

Sample 1: 40 ml of 1 mg/L NT in Chloroform

Sample 2: 40 ml of 1 mg/L NT in Chloroform with 30 mg of NTFB added in solution (Chemical formula is NO₂BF₄, NO₂ groups hole-dope the nanotubes)

Subsequently, silver epoxy was painted on to form two straight contact leads and the result was measured as:

Sample 1: 225.7 Ohms with a 32 mm×7 mm channel, thus the sheet resistance is 1031 Ohms/Sq

Sample 2: 123 Ohms with a 32 mm×7 mm channel, 562 Ohms/Sq sheet resistance

The only difference was the addition in one solution of the NTFB before deposition, thus, upon treatment with NO₂BF₄, the sheet resistance decreased by about a factor of 2.

### EXAMPLE 2

Deposit Nanotubes onto a Surface, Functionalize Subsequently

Another approach was to first lay down nanotubes on a substrate from chloroform, paint on the contacts, measure the sheet resistance, followed by filtering through a solution of NTFB in water on top of that, or to soak the sample in a solution of NTFB in water.

Sample 1: made a sample of HPCo NT on alumina and measured

a sheet resistance of 726 Ohms/Sq

Sample 2: Took above sample 1 and sucked through a mixture of NTFB in water, 100 ml of water with 30 mg NTFB. After drying in oven and letting cool (overnight), the new sheet resistance was measured to be 384 Ohms/Sq, again a decrease of approximately a factor of 2.

### EXAMPLE 3

Device with spincoated composite deposited from nanotube—SDS solution on Si/SiO₂ (500 nm) die and attached wires to source/drain (20 μm separation).

Backgating

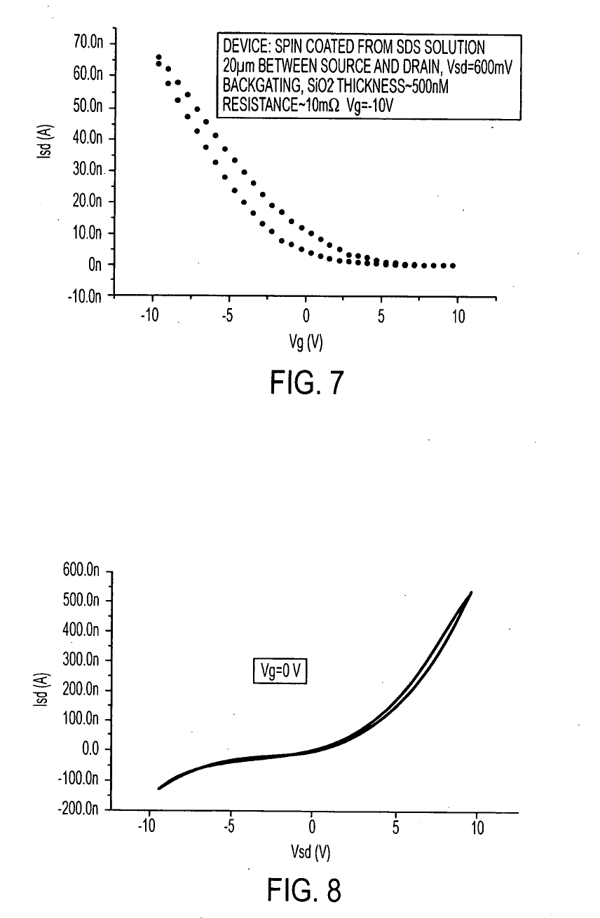

FIG. 7 shows the dependence of the source-drain current on the back-gate of a transistor device with spin-coated nanotube network.

The device has high ON/OFF ratio, which is at least several hundreds. Due to low signal, the inventor couldn't measure it more accurately even with all noise removal tools he had. The Isd(Vsd) characteristic is linear if Vsd is within 200 mV at Vg-0V. No saturation at Vsd from −10V to +10V was seen.

FIG. 8 shows the dependence of the source-drain current on the source-drain voltage of a transistor with a nanotube network conducting channel.

### EXAMPLE 4

Fabrication of Transparent and Conducting Pristine Nt Film on

Parylene C

Step 1: Solubilization of Nanotubes

Purified HPCo nanotubes (average diameter 2 nm; average length 2 um; obtained from Nanomix Inc.) were sonicated in chloroform for 30 minutes to dissolve and de-bundle the nanotubes, making a solution with 0.2 mg NT per Liter of chloroform.

Step 2: Deposition of Uniform NT Film on Alumina filter:

In order to produce quick, uniform films of single wall nanotubes, we used a vacuum filtration method, which involves vacuum filtering a dilute suspension of nanotubes in a solvent over a porous alumina filtration membrane (Whatman, 20 nm pore size, 47 mm diameter). This solution was then quickly vacuum filtered through a 60 micron thick alumina membrane (time scale of a few seconds). As the solvent falls through the pores, the nanotubes are trapped on the surface of the filter, forming an interconnected network. The density of this network (nanotubes/area) can be controlled with high precision, by simply controlling the volume of dilute suspension filtered through the membrane.

Step 3: Deposition of Parylene C by Evaporation

Parylene is a polymer which is deposited in vapor form under medium vacuum conditions (˜10⁻² Torr), and forms a truly conformal coating on all exposed surfaces of the substrate. Deposition occurs in three steps: vaporization, pyrolysis, and polymerization. The powder dimer form is first vaporized into a gas. Then the gaseous dimer molecules are cleaved into monomers using a high temperature furnace. Finally the gaseous monomers polymerize on the substrate which is at room temperature. The thickness of the parylene C can easily be controlled by the mass of the input Parylene C material. The typical thickness is 5 um for peeling off purpose.

Step 4: Peel Parylene C with NT Off the Alumina Filter

Step 5: Removal of the Parylene Plus Nanotube Network

The parylene C film can be peeled off. After this process, substantially no NT remains on the alumina filter.

The same method can be used for the deposition of a network that has been functionalized with a chemical before deposition onto a substrate. In this case the following steps are performed:

1. application of the solubilization agent

2. application of the functionalization agent in solution

3. deposition to a surface

4. coating with a second layer

5. removing the nanotube plus the second layer from the substrate

An Ink, or Nanotube in a Solution that Includes the Following Components

1. solvent, such as chloroform or water
2. solubilization agent, such as the surfactant SDS, and starch
3. functionalization agents
   that donate electron or holes to the nanotubes
   Exemplary Hole Donors:
      Organic compounds, such as TCNQ (Tetracyanoquinodimethane) and TCNE (Tetracyanoethylene)
      Inorganic species, such Br (bromine), Cl (chlorine), I (iodine), SOCl₂ (thionyl chloride), SO₃ (sulphur trioxide), NO₂ (nitrogen dioxide), NOBF₄ (nitrododium tetrafluoroborate), and NO₂BF₄ (nitronium tetrafluoroborate).
      Electron Donors
      PEI (poly-ethylene-imine).
That increase the nanotube-nanotube interconnect conductance
4. carbon nanotubes.
   A Printing Method for Carbon Nanotube Thin Films

This section describes a fabrication method for carbon nanotube thin films on various substrates including PET (polyethylene), glass, PMMA (polymethyl-methacrylate), and silicon, according to an embodiment of this invention. The method combines a PDMS (poly-dimethysiloxane) based transfer-printing technique with vacuum filtration, and allows controlled deposition—and patterning if needed—of large-area, highly-conducting carbon nanotube films with high homogeneity. The performance characteristics of the films fabricated meet or surpass the characteristics of other materials used as conducting and transparent conducting coatings on flexible substrates. With the recyclable use of filters and stamps, the method offers large area fabrication at an industrial scale.

While several exceptional properties of carbon nanotubes have been demonstrated (McEuen P. L.; Fuhrer M. S.; Park H. K. IEEE Trans. Nano. 2002, 1, 78), manufacturability and system integration is required for the exploitation of these attributes. There has been growing interest in single wall carbon nanotube thin films for applications in the area of macroelectronics (Reuss R. H. et al. Proc. IEEE 2005, 93, 1239; Bradley K.; Gabriel J. C. P.; Grüner G. Nano Lett. 2003, 3, 1353; Zhou Y. X.; Gaur A.; Hur S. H.; Kocabas C.; Meitl M. A.; Shim M.; Rogers J. A. Nano Lett. 2004, 4, 2031; Snow E. S.; Novak J. P.; Campbell P. M.; Park D. Appl. Phys. Lett. 2003, 82, 2145; Wu Z. C.; Chen Z. H.; Du X.; Logan J. M.; Sippel J.; Nikolou M.; Kamaras K.; Reynolds J. R.; Tanner D. B.; Herbard A. F.; Rinzler A. G. Science 2004, 305, 1273), in applications such as organic light emitting diodes (OLEDs) and polymer based solar cells, where flexible, transparent and conducting coatings together with room temperature fabrication are required. Carbon nanotube thin film transistors have reached and exceeded the performances of devices based on semiconducting polymers and amorphous silicon and carbon nanotube films have also shown some promise as a transparent and conducting coating. However large-scale fabrication methods required for applications have been elusive. It is difficult to control tube density and diameter for nanotube films grown by chemical vapor deposition (CVD), and the method is also limited because of the need for high temperatures for the nanotube growth. In addition, CVD grown films cannot exceed a monolayer (Zhou Y. X.; Gaur A.; Hur S. H.; Kocabas C.; Meitl M. A.; Shim M.; Rogers J. A. Nano Lett. 2004, 4, 2031), a thickness too small for transparent coating applications. Deposition using filters, while leading to reproducible and high quality films, is limited by the filters and requires consistent transfer to flat substrates for further applications (Wu Z. C.; Chen Z. H.; Du X.; Logan J. M.; Sippel J.; Nikolou M.; Kamaras K.; Reynolds J. R.; Tanner D. B.; Herbard A. F.; Rinzler A. G. Science 2004, 305, 1273; Armitage N. P.; Gabriel J. C. P.; Gruner G. J. Appl. Phys. 2004, 95, 3228; Hu L. B.; Hecht D. S.; Grüner G. Nano Lett. 2004, 4, 2513). Direct deposition on a desired surface using spin coating, spraying or incubation on the other hand does not lead to films with performance characteristics that are comparable to that of other materials.

The fabrication method according to an embodiment of this invention preserves the exceptional properties of nanotubes, yields consistently reproducible nanotube films and allows large-scale industrial production. This method combines a PDMS (poly-dimethysiloxane) based transfer-printing technique (Meitl M. A.; Zhou Y. X.; Gaur A.; Jeon S.; Usrey M. L.; Strano M. S.; Rogers J. A. Nano Lett. 2004, 4, 1643) with vacuum filtration. It allows controlled deposition of large-area, highly-conducting carbon nanotube films with high homogeneity on various substrates, including PET (polyethylene), glass, PMMA (polymethyl-methacrylate), and silicon. The performance characteristics of the films compare favorably with indium-tin-oxide (ITO) and conducting polymers on flexible materials. The films can also be printed in a patterned fashion for use as building blocks in electronic devices.

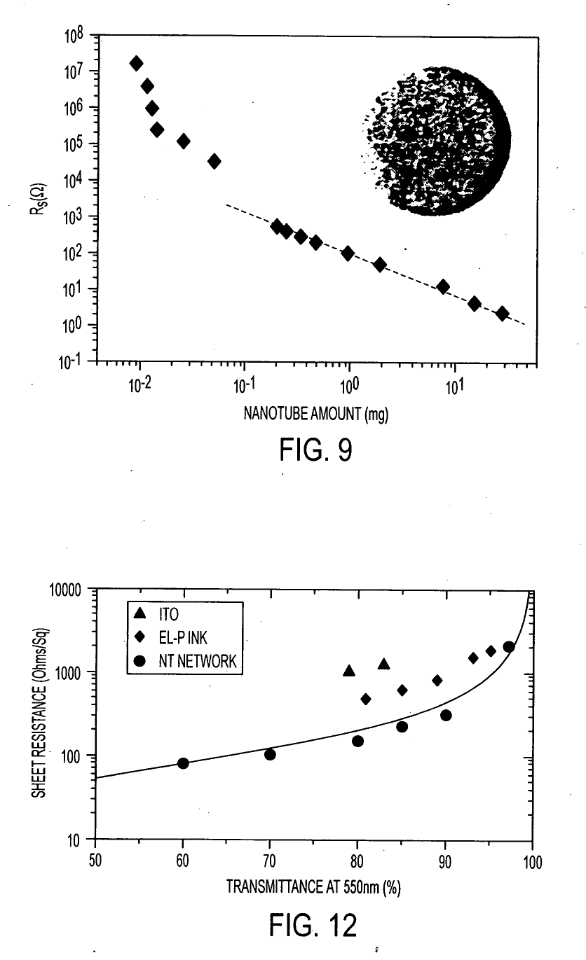

To prepare carbon nanotube films, we use commercially available purified pristine (undoped) arc discharge nanotubes with purity of 70-90% (Carbon Solutions, Inc.). Powders of carbon nanotubes are dissolved in 1% solution of sodium dodecyl sulfate (SDS) surfactant with a concentration of 0.01 g/L. Then the solution is bath-sonicated for 16 hours at 100 W and centrifuged at 15000 rcf (relative centrifugal field) for 30 minutes. Only the top ¾ part of the centrifuged solution is selected for further processing. Alumina filters with the pore size of 0.1-0.2 μm (Whatman Inc.) are used in the vacuum filtration (Armitage N. P.; Gabriel J. C. P.; Gruner G. J. Appl. Phys. 2004, 95, 3228; Hu L. B.; Hecht D. S.; Grüner G. Nano Lett. 2004, 4, 2513). After the filtration, the filtered film is rinsed by deionized water to remove SDS surfactant for several minutes until no bubble is seen. The inset of FIG. 9 shows a photo image of a homogeneous nanotube film on a filter with two-inch diameter. As shown in FIG. 9, depending on the density of the network—proportional to the thickness of the “film”—the sheet resistance can be varied over a wide range by controlling the amount of nanotubes used. For nanotube networks just above the percolation threshold, the sheet resistance reduces dramatically with the increase of nanotube amount, while in the region far from the threshold, the sheet resistance decreases inversely with the network density, or film thickness, as expected for constant conductivity.

FIG. 9 shows sheet resistance of carbon nanotube thin films as the function of the nanotube amount Note that the “nanotube amount” is proportional to the network density, or film thickness. In the region far from the percolation threshold, the sheet resistance decreases inversely with the amount of nanotubes consumed as indicated by the dotted line. The inset shows a photograph of a uniform two-inch diameter carbon nanotube film (grey region) on a filter.

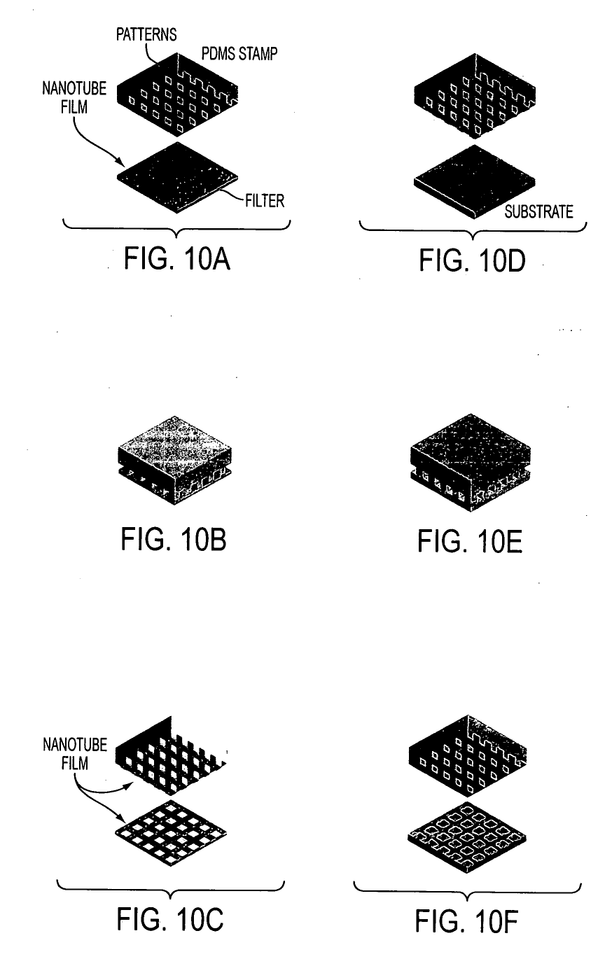

PDMS stamps for transfer printing are fabricated by using SYLGARD® 184 silicone elastomer kit (Dow Corning Inc.) with silicon substrates as masters. To make patterned PDMS stamps, SU-8-25 resist (MicroChem Inc.) is spun onto silicon substrates and patterned by standard optical lithography. Silicon masters are pretreated with two hours of vacuum silanization in the vapor of (Tridecafluoro-1,2,2-tetrahydrooctyl)-1-trichlorosilane. Subsequently the silicone elastomer base and the curing agent are mixed together with a ratio of 10:1. After two hours of curing in the vacuum to remove the bubbles, the mixture is cast onto the silicon master, which is followed by one hour of vacuum curing and two hours of oven baking at 65° C. Finally, the PDMS stamp is removed from the silicon master. FIG. 10(a) illustrates a patterned PDMS stamp, together with the fabrication process.

FIG. 10(a) Illustrates a patterned PDMS stamp and carbon nanotube films made by vacuum filtration. FIG. 10(b) shows conformal contact between the PDMS stamp and carbon nanotube films on the filter. FIG. 10(c) shows, after the conformal contact, the PDMS stamp is removed from the filter. Patterns of carbon nanotube films are transferred onto the PDMS stamp without any damage. FIG. 10(d) shows the PDMS stamp with patterned carbon nanotube films and a flat receiving substrate. FIG. 10(e) shows conformal contact between the PDMS stamp and the substrate. FIG. 10(f) illustrates that after removing the PDMS stamp from the substrate, substantially all patterned nanotube films on the stamp are fully transferred onto the substrate.

To remove the nanotube films from the filters, we first make the conformal contact between the stamp and the films on the filter (FIG. 10(b)). As soon as the wetting due to the conformal contact is seen, the stamp is raised from the filter and the patterned films are transferred onto the stamp (FIG. 10(c)). Transfer of nanotube films from one surface to another surface is guided by surface energies of the two surfaces (Krevelen D. W. V. Properties of Polymers; Elsevier: Amsterdam, 1997). Since the nanotube films loosely sit on the alumina filters, they can be fully transferred onto the PDMS surface even though PDMS has a low surface energy of 19.8 mJ/m². Even for nanotube films with a high sheet resistance of 100Ω (and consequently of small nanotube density), the leftover on the filter has a resistance larger than 100 MΩ, the limit of our multimeter. We note that the same filter can be reused for fabrication of another film.

The availability of patterned nanotube films on PDMS stamps (FIG. 10(d)) readily allows them to be printed onto various flat substrates with a higher surface energy, such as PET (44.6 mJ/m²), glass (47 mJ/m²), and PMMA (41 mJ/m²). The surface energy of silicon substrates can be increased by oxygen plasma cleaning and vapor silanization using (aminopropyl)triethoxysilane. To start the transfer, we first contact the PDMS stamp with nanotube films onto the receiving substrate (FIG. 10(e)). After 10 minutes of mild heating at 80° C., substantially all nanotube films on the stamp are transferred onto the receiving substrate by simply removing the stamp from the substrate (FIG. 10(f)).

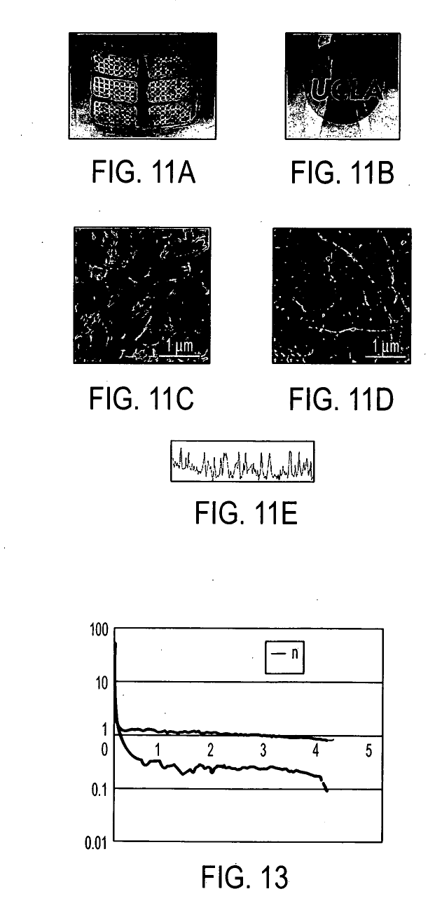

FIG. 11(a) is a photograph of patterned nanotube films on a PET substrate. The small grey square patterns have a size of 1 mm². FIG. 11(b) is a photograph of a transparent and homogeneous film with two-inch diameter on a flexible PET substrate. FIG. 11(c) is an AFM image of a nanotube film with a sheet resistance of 200 Ωon a glass slide. The clean film has a roughness of approximately 8 nm. FIG. 11(d) is an AFM image of a sub-monolayer nanotube film with a sheet resistance of 100 KΩ on a glass slide. FIG. 11(e) is a section analysis of the AFM image in FIG. 11(d) across the black line. The nanotube bundle size is 3-6 nm.

FIG. 11(a) shows a photo image of 1 mm square pattern arrays of nanotube films on a flexible PET substrate. The smallest pattern size achieved is 20 μm, limited by the SU-8-25 resist based optical lithography to make the silicon master. Usage of PDMS stamps with smaller feature sizes (Meitl M. A.; Zhou Y. X.; Gaur A.; Jeon S.; Usrey M. L.; Strano M. S.; Rogers J. A. Nano Lett. 2004, 4, 1643; Rogers J. A.; Bao Z. N.; Baldwin K.; Dodabalapur A.; Crone B.; Raju V. N.; Kuck V.; Katz H. E.; Amundson K.; Ewing J.; Drzaic P. Proc. Nat. Acad. Sci. (USA) 2001, 98, 4835) may lead to patterns of nanotube films with higher resolution. FIG. 11(b) shows a photo image of a transparent and homogeneous film with a two-inch diameter on a flexible PET substrate. Recyclable use of filters and stamps may allow utilization of high cost large area filters and PDMS stamps at the industrial scale without significantly increasing the fabrication cost of thin films.

FIG. 11(c) shows an AFM image of a nanotube film with a sheet resistance of 200Ω on a glass slide. The root mean square roughness of the film is 8 nm as estimated from the AFM image. Examining the edge of the film, we obtain the film thickness of 25 nm, this leading to a conductivity of 2000 S/cm. Similar evaluations of other films lead to conductivities of 1600-2000 S/cm. The measured conductivity allows us to assess the overall quality of the films, in comparison with films fabricated by methods reported in the literature. Films deposited directly onto various surfaces do not exceed the conductivity value of 200 S/cm. Films, deposited on a filter have high conductivity, in fact exceeding our results by about a factor of 3. Several factors are responsible for such differences. Direct deposition leads to large bundles on nanotubes, and, if the current flows at the outer layer of the bundles, to a conductivity that decreases with increasing bundle size. For films reported here the nanotube bundle size is 3-6 nm, compared to the 20 nm bundle size and 200 S/cm obtained in by us earlier. We have, in fact have seen increases of the order or 3 by doping our films with electron withdrawing species such as SOCl₂.

In order to examine the quality of our films further, and explore their application potential as a transparent conducting film we have also performed optical transmittance (T) measurements in the visible spectral range, using a Beckman coulter DU 640 spectrophotometer. In evaluating the optical transmittance of the film, as a first approximation, we have measured the optical transmittance of the PET substrates T_{sub}, and the optical transmittance measured for the nanotube film plus substrate, T_{NT+sub} was divided by T_{sub}.

FIG. 12 shows optical transmittance T of a nanotube film on the PET substrate at 550 nm as function of sheet resistance. Also included are films based on an organic polymer and ITO in a polymer. The inset shows the wavelength dependence of the transmittance of a typical film over the visible spectral range. The fill line is the expected relation between sheet resistance and optical transmittance.

The film thickness of 10-40 nm is significantly less than wavelengths in the visible and infrared regions. Under such conditions, the optical conductivity σₒₚ and the DC conductivity σ_{dc} determines the relation between the optical absorption A and sheet resistance Rₛ. Assuming that T is determined by the optical absorption in the film, the relation between T and the sheet resistance (Hu L. B.; Hecht D. S.; Grüner G. Nano Lett. 2004, 4, 2513; Dressel, M.; Gruner G. Electrodynamic of Solids: Optical Properties of Electronics in Matter; Cambridge University Press: Cambridge, 2002) is given by

$$T = {( 1 + \frac{1}{2 {R}_{s}} \sqrt{\frac{{μ}_{0}}{{ɛ}_{0}}} \frac{{σ}_{op}}{{σ}_{dc}} )}^{- 2} = {( 1 + \frac{188 ( Ω )}{{R}_{s}} \frac{{σ}_{op}}{{σ}_{dc}} )}^{- 2} \qquad ( 3 )$$

where the free space permeability μ₀=4π×10⁻⁷ s²/F/m and permittivity ε₀=8.8542×10⁻¹² F/m. FIG. 12 shows T measured at 550 nm for films with different sheet resistances. A fit to our data, together with the measured average dc conductivity of 1600 S/cm leads to σₒₚ=175 S/cm at 550 nm. This value is close to σₒₚ=200 S/cm obtained on thick nanotube films, confirming, in a somewhat indirect fashion, the dc conductivity values we have measured directly.

In conclusion, we have described a process according to an embodiment of this invention that can provide carbon nanotube films on various substrates (including PET, glass slide, PMMA and silicon) by using vacuum filtration and PDMS based transfer printing, and have shown that such method can lead to films that exceed the conductivity of films arrived at by direct deposition by about one order of magnitude.

This method also provides usefulness due to it's competitive position with respect to other materials used, and therefore a few comments on this aspect of the invention follow. First, the recyclable use of filters and stamps allow up-scaling of the fabrication of films. Second, the performance characteristics are similar, or exceed that of other materials used to date. On FIG. 12 we have included a recent, polymer-based transparent conductor, offered by AGFA, and the performance of ITO on a plastic surface. Note that lower sheet resistance for the same T leads to increased performance. ITO is readily used in a variety of applications, and we conclude that carbon nanotube films according to embodiments of this invention have technical characteristics that allow applications in areas where flexible coatings are required, such as transparent EM shielding, smart windows, touch screen displays, solar cells, OLEDs and flat panel displays. A third, factor is the cost of the material and of the process being used. The cost of the fabrication process is expected to be less that that for ITO for which high temperatures and vacuum deposition is required. The cost of the material can be calculated using the cost of starting material, the material loss during purification and deposition and the nanotube amount required for, say for a film with 80% transmittance. Based on our current purchase price of $400/g for purified nanotubes, the material cost is about $64/m², a figure comparable to the current price of commercially available ITO. With the abundance of carbon, the price of carbon nanotubes is expected to decrease with further commercialization, contrasted to the steady increase of the price of ITO. In view of at least the attributes discussed above, we believe that carbon nanotube films will find their application in a variety of areas that require flexible, transparent and/or conducting coatings in a patterned or non-patterned form. However, this invention is not limited to only those applications.

Optical Transmission, Reflection and Absorption of a Carbon Nanotube Film.

Three parameters: (1) Reflection R, (2) Transmission T, and (3) Absorption A characterize the optical performance of various films. Note that T+A+R=1.

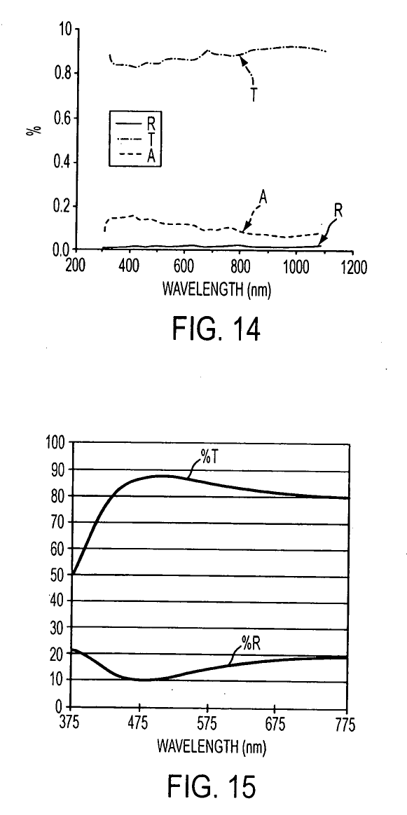

The three components can be evaluated using the total transmission measured and the optical constants as evaluated by Ruzicka et al Phys Rev B 61, 2468 (2000). The optical parameters n and k (see FIG. 13), the optical transmission T, absorption A and reflection are displayed in FIG. 14. The transmission measured for a carbon nanotube network on a transparent substrate, such as glass, according to the current invention, has been analyzed using a two layer model as described in M. Dressel and G. Gruner Electrodynamics of Solids Cambridge University Press 2000.

The nanotube film is characterized by a small reflection R and large absorption A in contrast to an indium-tin-oxide film where the reflection R is significantly larger than the absorption A and is the main factor that reduces the transmission to less than 100%, as shown on FIG. 15.

FIG. 13 shows the optical parameters n and k of carbon nanotube networks according to the current invention. These parameters were calculated using the transmittance at 550 nm as measured on a film with finite thickness and the optical data at different frequencies by Ruzicka et al Phys. Rev B 61, 2468 (2000).

Summary of Some Aspects of Highly Conducting Carbon Nanotube Networks on a Substrate.

Transparent and electrically conducting coatings and/or electrodes require a transparency exceeding 80% and a sheet resistance less that 1000 Ohms for many applications.

One can characterize overall performance by the parameter called conductivity. A higher conductivity is desirable for applications in the area of transparent coatings and electrodes. The transparency and sheet resistance depend, in addition to the conductivity, on the nanotube network density. For the same conductivity, higher density leads to smaller sheet resistance and smaller transparency.

### SUMMARY OF THE PRIOR ART

Transmittance refers to the optical transmittance at 550 nm. It refers to T=1-A where A is the optical absorption, see L. Hu et al Nano Letters 5,757 (2005).

1. Prior art involving nanotube networks on transparent substrates (substrate transparency more than 90%) may provide networks with conductivity less than 500 S/cm (N. Saran et al J. Am. Chem. Soc 126, 4462 (2004); M. Kaempgen et al Applied Surface Science 252, 425 (2005)).

2. Prior art networks on surfaces with low transparency (less that 75%) and free standing networks may result in transmittance less than 80% even though a conductivity of 6400 S/cm has been achieved. Networks on surfaces with low transparency lead to overall low transparency of the network plus substrate. Free standing networks have to be dense, i.e., too dense for applications (Z. Wu et al Science 305, 1273(2004)).

3. Very thin, chemical vapor deposition (CVD) grown networks may result in a transmittance of more than 98% and a conductivity of 10 000 S/cm. However, dense networks with sheet resistances less that 1000 Ohms have not been fabricated by this method (J. C. Gabriel Mat. Res Soc Symp. Proc. Vol 776 Q12.7.1. (2003)).

Results Obtained by Some of the Embodiments of the Current Invention

1. Pristine, non-doped networks
Transmittance: 70-97%
Conductivity: 2400 S/cm undoped (average).

2. Doped network
1. To test the effects of chemical doping on the sheet resistance of the nanotube networks, first several nanotube network samples were prepared by sonicating HpCO tubes, obtained from Carbon Nanotechnologies Inc., in Chloroform and depositing them on an alumina filter membrane.

Two different samples, with the following characteristics were prepared:
Sample 1: 40 ml of 1 mg/L NT in Chloroform
Sample 2: 40 ml of 1 mg/L NT in Chloroform with 30 mg of NO2BF4)
   Subsequently silver epoxy was painted on to form two straight contact leads and the results were measured as:
Sample 1: 225.7 Ohms with a 32 mm×7 mm channel, thus a sheer resistance of 1031 Ohms/Sq
Sample 2: 123 Ohms with a 32 mm×7 mm channel, 562 Ohms/Sq sheet resistance

The only difference was the addition in one solution of the NO2BF4 before deposition to Sample 2, thus, upon treatment with NO2BF4, the sheet resistance decreased by about a factor of 2.
2. Doping has also been performed by subjecting the network, using tubes fabricated by laser ablation (Max Planck Institute for Festkorperforscchung, Stuttgart, Dr. J. Ceck) to an NO2 environment. A nanotube network having a sheet resistance of 320 Ohms, and a transparency of 82% (conductivity 2400 Ohmscm-1) was subjected to an NO2 atmosphere of approximately 100 ppm. A decrease of the sheet resistance to 110 Ohms was observed. This leads to an increase of the conductivity by a factor of 320/110=2.9, leading to:
Transparency: 80-90%
Conductivity after NO2 doping: 7100 S/cm
   3. Printing method of nanotube network fabrication

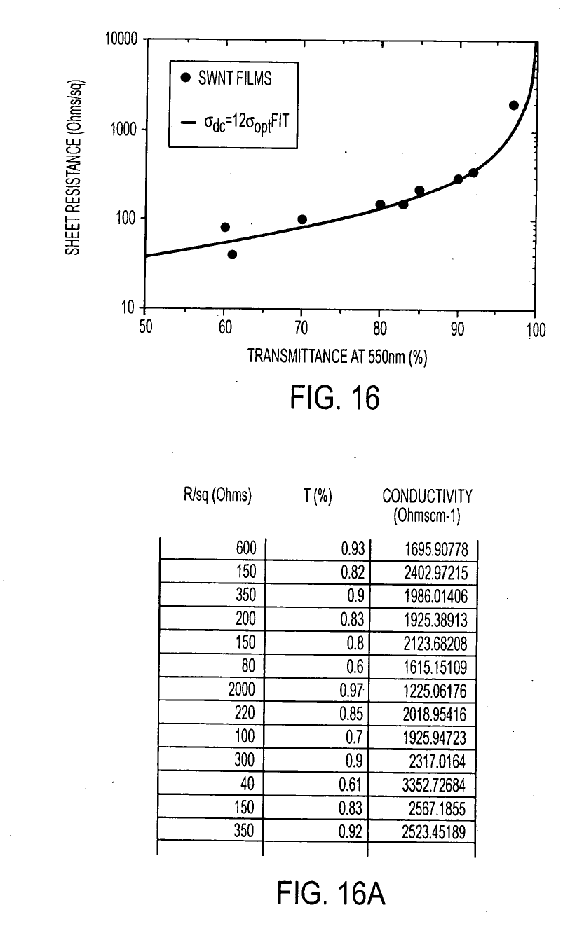

FIG. 16 shows the sheet resistance and transparency of pristine nanotube networks at various network densities produced according to the printing embodiment of this invention. The full line corresponds to a network conductivity of 2400 S/cm. Performance of individual networks are listed in Table 1.

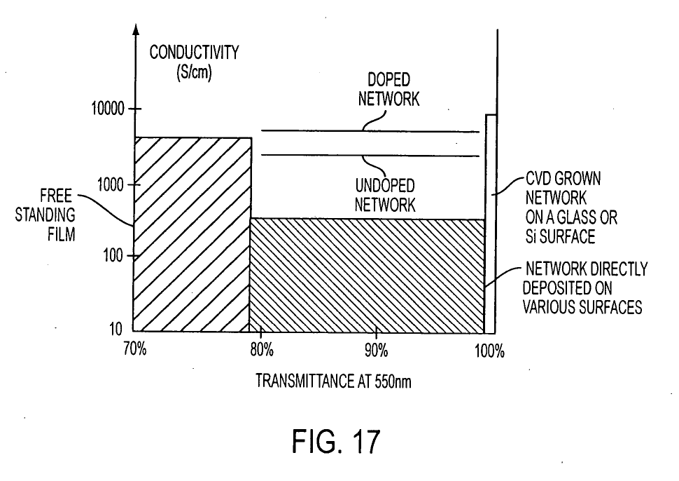

FIG. 17 summarizes the performance characteristics of undoped carbon nanotube networks according to the prior art and embodiments according to the current invention. Shaded areas represent prior art nanotube networks. The zone on the left in FIG. 17 corresponds to free-standing nanotube networks which have low transmittance. The central shaded region corresponds to nanotube networks deposited on substrates for which the conductivity is low. The narrow shaded region to the right in FIG. 17 corresponds to CVD grown carbon nanotube films which can only be grown to very thin films that have an average thickness of about 1 nm, or less. This method has not been shown to be able to grow films having average thicknesses greater than 2 nm. It is desirable to have carbon nanotube networks that have an average network thickness greater than 2 nm, conductivity greater than 600 S/cm and a transmittance greater than 80%. According to another aspect of the current invention, it is desirable to have carbon nanotube networks that have an average network thickness greater than 2 nm, conductivity greater than 1000 S/cm and a transmittance greater than 80%. According to another aspect of the current invention, it is desirable to have carbon nanotube networks that have an average network thickness greater than 2 nm, conductivity greater than 2400 S/cm and a transmittance greater than 80%. According to another aspect of the current invention, it is desirable to have carbon nanotube networks that have an average network thickness greater than 2 nm, conductivity greater than 7000 S/cm and a transmittance greater than 80%.

Methods of Evaluating the Conductivity

The conductivity has been evaluated in two different ways. First, the thickness of the film can be measured using an AFM probe. Second, the resistance can be measured and from the area the sheet resistance R/sq—the resistance of a 1 cm2 film-can be evaluated. For example form Table 1, Row 5

R/sq=150 Ohms

Thickness d=30-35 nm

The resistivity is R/sq×d and the conductivity is 1/resistivity. From this
Conductivity=1900-2200 S/cm.

The optical absorption to good approximation is 1-T where T is the optical transmission. The reflection is less than 10% of A. The well-known relation between the conductivity and T can be used to evaluate the conductivity using the procedure as described in L. Hu et al Nano Letters 5,757 (2005). This procedure (see Row 5 in Table 1) leads to
Conductivity=2123 S/cm,
   agreeing with the value evaluated using the film thickness.
4. Further improved performance
   1. Longer nanotubes.
      Current length used: 1 to 2 microns.
      Conductivity increases as the square of the length.

In M. Kaempgen et al Applied Surface Science 252, 425 (2005), longer tubes lead to higher conductivity. Such longer carbon nanotubes can be readily used in embodiments of the current invention, for example to produce carbon nanotube networks according to the printing method of the current invention.
2. Increasing the conductivities with doping
3. Enhanced fraction of metallic tubes

In Haddon et al MRS Bulletin 252, 2004, a method is described to separate metallic and semiconducting tubes.
4. Reduced bundle size
   Electronic Materials Formed by Multiple Interpenetrating Networks of Nano-Scale Materials and Layers

Additional embodiments of the present invention relate to structures that incorporate either multiple networks of nano-structured materials or multiple layers in which such networks are incorporated. These types of networks which employ combinations of nano-structured materials are referred to herein as “interpenetrating” nano-scale networks.

The structures that form part of the invention include:

1. two or more interpenetrating nano-scale networks as an electronic material (having a finite electronic conduction) and the various methods that may be used to fabricate such networks. The networks can be free-standing or on a substrate. More particularly, the present invention is directed to a multitude of interpenetrating nano-structure networks that are suitable for use in electronic applications, such as resistors, diodes, transistors, solar cells and sensors;

2. a three component structure: a (1) substrate and (2) functional layer together with a (3) network or networks of nano-structured materials; and a (I) substrate together with a (2) network or networks of nano-structured materials and an encapsulation layer (3), together with

3. a four component structure: a (1) network or networks together with a (2) functional material on a (3) substrate and an (4) encapsulation material that prevents the functional material to be removed from the network and substrate, and the various methods that may be used to fabricate such structures that are suitable for use in electronic applications, such as resistors, diodes, transistors solar cells and sensors;

4. The combinations of the above.

Examples which embody the present invention include:

Structures:

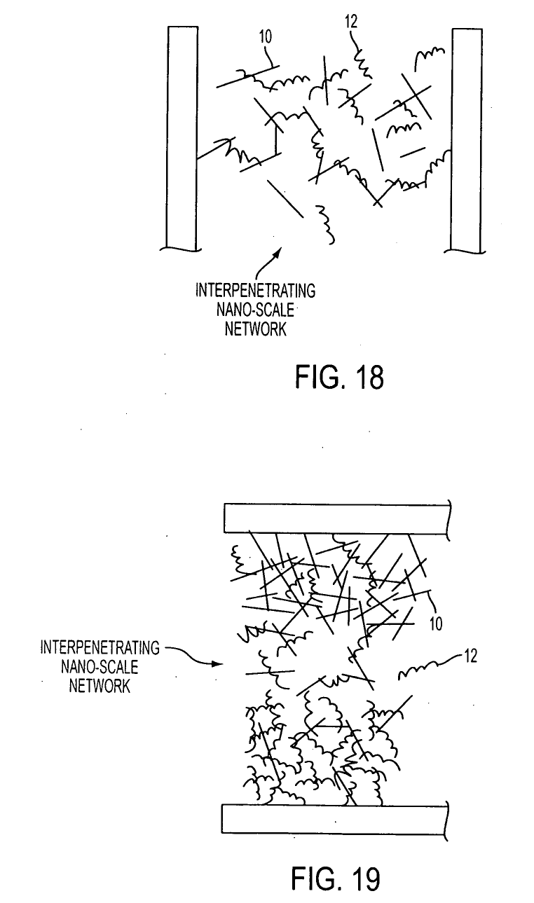

1. two or more interpenetrated nano-structure networks (also referred to herein as “nano-particle networks”), as illustrated in FIG. 18, where there are two or more different nano-structures present as represented at 10 (e.g. nanotube) and 12 (e.g. nanoribbon).

The two different nano-structures may be of the same type, e.g. both nano wires, but they should have at least one different property. The two different nano-structures can be any of those previously mentioned including nanoparticles, nanowires, nanofibres, nanoribbons, nanoplates and nanotubes. Other types of nanostructured materials such as a sol-gel produced silica, arerogels, and activated carbon also are included in the application. Combinations of more than two different types of nano-structures are possible. The density of one or each of the nano-particle networks can be below or above the percolation threshold but taken together the entire network is above the percolation threshold. Two interpenetrated networks, such as a cloth, other clothing materials such as leather and a conducting nanostructures or nano-particle networks also are included within the present invention.

2. two networks where in one region one and in another region the other component is more dense such as shown in FIG. 19

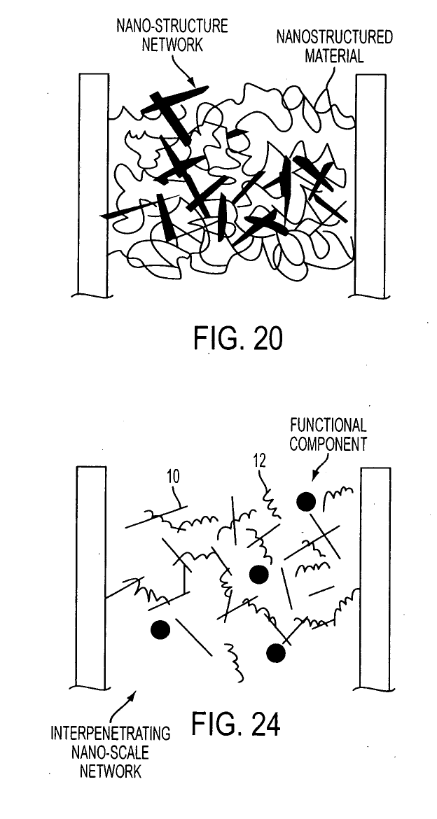

3. a nanoparticle-nanostructured material combination such as depicted in FIG. 20

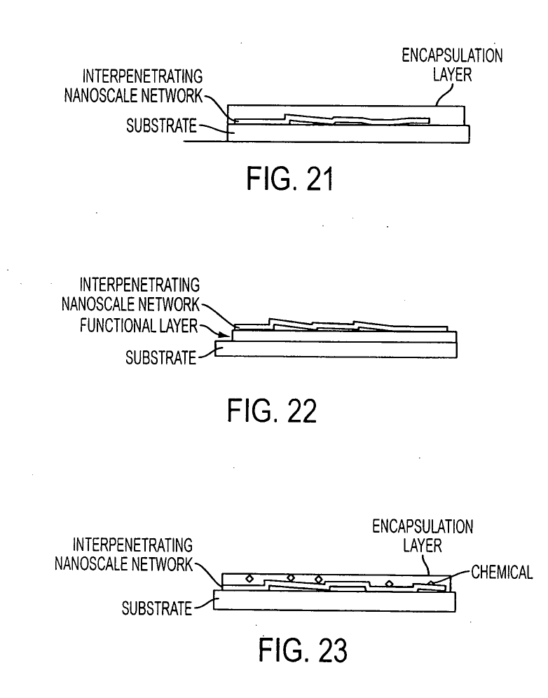

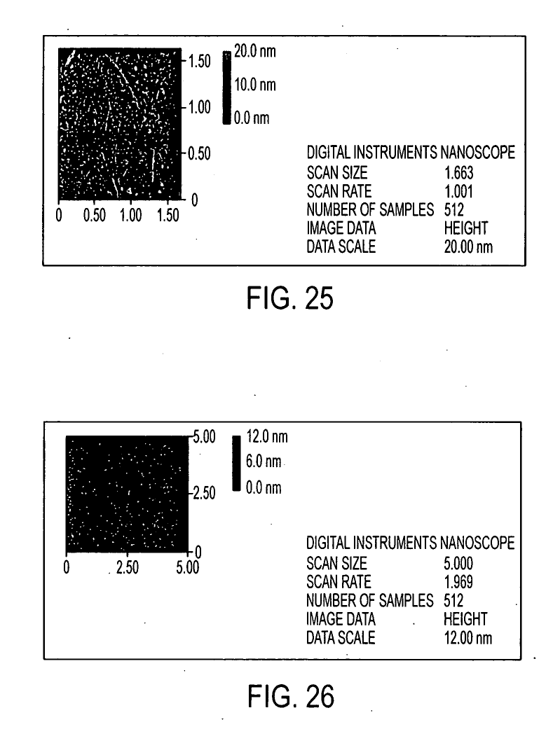

4. a multilayer structure, illustrated in FIG. 21, the incorporates a substrate, a nanowire network and an encapsulation layer

5. a multilayer structure that includes a substrate, a “functional layer”, a nano-particle or multiple nanoparticle network such as shown on FIG. 22

6. an architecture that incorporates a substrate, and nanowire network, another “functional component”, such as a chemical or nano-structured material and an encapsulation layer (FIG. 23). The structure alleviates the problem of easy removal of the “functional material” by encapsulating the (nanotube+functional material) with a layer

7. Combinations of the above, including two networks such as depicted in FIG. 1 together with a “functional component”, shown in FIG. 24

Materials

1. Examples of the nano-scale materials that can form the two nano-structure networks with different electrical properties include

inorganic nanowires,

polymeric nanofibers,

carbon nanotubes,

organic fibers such as that from cloths

metallic nano-particles,

biological materials, such as a protein or DNA,

nano-structured light sensitive materials, such as a

PMPV nanoporous materials such as aerogels, and

activated carbon.

2. The functional component in FIG. 21 can be:
Organic compounds such as
   Tetracyanoquinodimethane TCNQ
   Tetracyanoethylene TCNE,
polymers with electron acceptor groups, such as
   polyethylene imine
   Inorganic species such as
   bromine (Br) chlorine (Cl) iodine (I)
   thionyl chloride (SOCl₂)
   sulphur trioxide (SO₃)
   nitrogen dioxide (NO₂)
   nitrododium tetrafluoroborate (NOBF₄)
   nitronium tetrafluoroborate (NO₂BF₄)
   Light sensitive materials such as porphyrine
3. The encapsulation agent in FIG. 21 and FIG. 23 can be a polymer such as a parylene, a PEDOT, PMPV,
light sensitive material, such as a poly((m-phenylenevinyle)-co-)-2,3.diotyloxy-pphenylene)),
PmPV
PMPV
4. The functional layer (FIG. 22) can be a polymer layer that prevents non-specific binding of biomolecules and/or sensitivity to serum such as poly-ethylene-glycol (PEG), Twenn 20, and PEO together with the combination of these polymer layers with electron donating or withdrawing properties, such as polyethylene-imine (PEI) materials with appropriate conducting/transparent property and electron affinity or ionization potential a layer of biomolecules such as bovin serum albumin (BSA).

Electronic devices that can be formed using the interpenetrating networks include:

1 electrical resistors or conductors

2. diodes

3. transistors

4. chemical and bio-sensors

5. components of solar cells

The following patent applications are incorporated herein to provide further details regarding the types of nano-structures that can be used to form the interpenetrating networks and structures of the present invention.
1. U.S. Ser. No. 10/846,072
2. PCT US05/03821
3. PCT US04/43179
4. PCT US04/28633
5. U.S. Ser. No. 10/431,963
6. U.S. 60/656,571—Transistors with Carbon Nanotube Components
   Nanotube-Gold Nanoparticle Composites

Nanotube-gold nanoparticle (NP) interpenetrating networks were fabricated in the following way:
1. 10 nm gold nanoparticles were deposited on a silicon wafer by incubation.
   The surface of silicon was pretreated with piranha and APTES.
2. A carbon nanotube network was deposited from solution both by sparing or incubating the wafer.

The nanoparticle network alone was found to be insulating. The inert-penetrating network was found to be electrically conducting, with the conductivity exceeding the conductivity of the nanotube network, indicating that the conduction process is through both networks. In addition, a field effect transistor has also been fabricated, with a mobility exceeding 1 cm2/Vsec, and on-off ratio of 20, demonstrating that screening effects due to the gold nanoparticled are negligible.

FIG. 15 shows an AFM image of the gold nanoparticle-carbon nanotube network. The architecture can also be functionalized by attacking various biomolecules such as single strand DNA using thiol chemistry well known in the literature. Thus the device can be used as a biosensor, detecting duplex formation. Other biomolecules, such as an antibody can also be attached, for ligand-receptor binding.

FIG. 26 shows 2.2 μm gold nanoparticles on a silicon wafer by incubation. The surface of silicon was pretreated with piranha and APTES.

A Substrate Plus PEDOT Conducting Polymer-Nanotube Network Architecture.

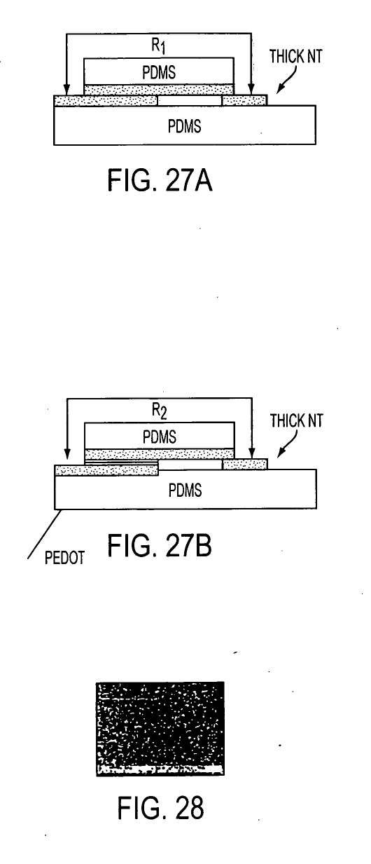

A substrate plus carbon nanotube-PEDOT polymer three-layer structure has been fabricated on a substrate. The structure is show on FIG. 27(a), with the dark green layer representing the PEDOT polymer. FIG. 27(a) represents a reference structure, without the polymer. The structure, depicted on FIG. 27(b) includes a PEDOT polymer layer. The different layers were deposited by spin-coating, while the carbon nanotube network was deposited though spraying from solution.

The geometry shown on FIG. 27. was used to measure the contact resistance between PEDOT and nanotube network. The sheer resistance of the nanotube network ˜10 ohms/sq.

The NT-PEDOT contact resistance measurement leads to the Pedot-NT interface resistance of ═(R2-R1)/2=(85-70)/2 Ohms cmˆ2=7.5 Ohm cmˆ2, indicating good electrical integration of the two layers.

Polyaniline-NT Network

A two-network architecture has been fabricated using a conducting polymer, polyaniline and a carbon nanotube network. A polyaniline-NT network can be fabricated by depositing first a polyaniline nanofiber network using the method described in J. Huang J. Am. Chem. Soc 125, 314 (2003), and FIG. 28. shows such nanostructured network of polyaniline.

Subsequently, a carbon nanotube network can be deposited using any of the deposition routes:

Spray coating: the simplest method involves spraying the solubilized nanotubes onto a surface. The quality of the network depends on the dispersion of the nanotubes in the solvent, and also on the properties of the surface. Additional factors are important. For example, having the surface heated past the boiling point of the solvent aids in ensuring film uniformity, but is not necessary for substrates that are not suitable for elevated temperatures.

Spin coating: The solubilized suspension of nanotubes can also be spun onto a surface along with methanol, which acts to remove the SDS. The resulting films have single tubes to small bundles (1-4 nm diameter).

Transfer Coating: In this unique approach, a nanotube network of a desired density is first made as above, using the vacuum filtration process onto an alumina filter. These networks can then be coated with a thin layer of an insulating, transparent polymer (Parylene C for example), and the networks ripped off of the substrate intact, as they become embedded in the polymer. This effectively transfers the nanotube network from one surface to another. In theory, using an appropriate solvent for the polymer, these networks can then be transferred to any desired substrate. Using this approach, one can fabricate networks of varying densities on substrates of varying thicknesses, yielding high controllability of the process.

Carbon Nanotube Sol-Gel Prepared Nanostructured Silica Networks

Networks of 0.4 mg/ml arc discharged Nanotubes were dissolved in DI water with 1% Sodium dodecyl sulphate (SDS) surfactant by weight. The solution was sonicated for one hour at 300 w using a probe sonicator and then centrifuged at 14000 rpm for one hour. After centrifugation, the suspension was decanted so that only the supernatant of the centrifuged material was included in the final suspension. Centrifuging and decanting removes large, heavier bundles from the suspension. The solution was filtered through a 0.2 um anodic membrane filter, followed by thorough water washing until no bubble was observed. The typical thickness of the film is 10 um. After the film was dried in air for 30 mins, it was transferred to carbon. Subsequently the silica sol-gel was filtered, using a vacuum pump, into the open volume of the nanotube film on a carbon paper substrate.

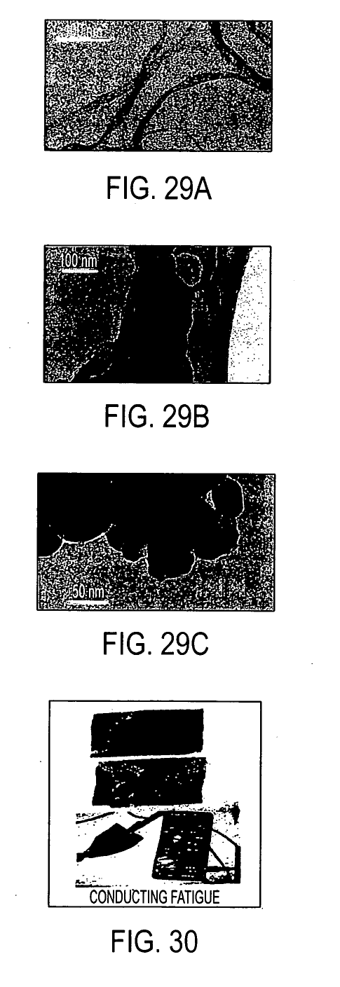

FIG. 29 shows TEM of carbon nanotubes and TEM of sol-gel carbon nanotube composite. Carbon nanotubes are integrated within silica aerogel particles. FIG. 29 is a TEM of silica aerogel particles.

Carbon Nanotube-Fabric Composites

1. A conducting fabric can be produced by spraying nanotubes onto a fabric. Spraying leads to a well dispersed network of the nanoscale fabric material and nanotube network, and to appropriate conducting properties. A fabric with spar coated nanotube is shown in FIG. 30. In addition to becoming conducting, the fabric retains it's color, due to the high transparency of the nanotube network. In general, several methods can be used for coating the fabric.

Spray coating: the simplest method involves spraying the solubilized nanotubes onto a surface. The quality of the network depends on the dispersion of the nanotubes in the solvent, and also on the properties of the surface. Additional factors are important. For example, having the surface heated past the boiling point of the solvent aids in ensuring film uniformity, but is not necessary for substrates that are not suitable for elevated temperatures.

Spin coating: The solubilized suspension of nanotubes can also be spun onto a surface along with methanol, which acts to remove the SDS. The resulting films have single tubes to small (1-4 nm diameter) bundles.

Transfer Coating: In this unique approach, a nanotube network of a desired density is first made as above, using the vacuum filtration process onto an alumina filter. These networks can then be coated with a thin layer of an insulating, transparent polymer (Parylene C for example), and the networks ripped off of the substrate intact, as they become embedded in the polymer. This effectively transfers the nanotube network from one surface to another. In theory, using an appropriate solvent for the polymer, these networks can then be transferred to any desired substrate. Using this approach, one can fabricate networks of varying densities on substrates of varying thicknesses, yielding high controllability of the process.

1. In addition to pristine nanotubes, the nanotubes can be functionalized, coated with various chemicals that have a functional character. Such chemicals can be light sensitive, or sensitive to gases, and biological molecules thus acting as a chemical or biological sensor, or an optoelectronic device.

2. In addition, another layer or layers can be sprayed or deposited onto the fabric plus NT network, leading to other functionalities. For example, a layer that leads to charge separation, together with another transparent electrode layer can be fabricated using techniques described in the MRS Bulletin, Vol 30 No. 1 Jan. 2005 “Organic based Photovoltaics.”

### SUMMARY OF SOME APPLICATIONS OF THE CURRENT INVENTION

Applications that include multiple layers where at least one layer is a carbon nanotube, or nanowire, network include, but are not limited to the following.

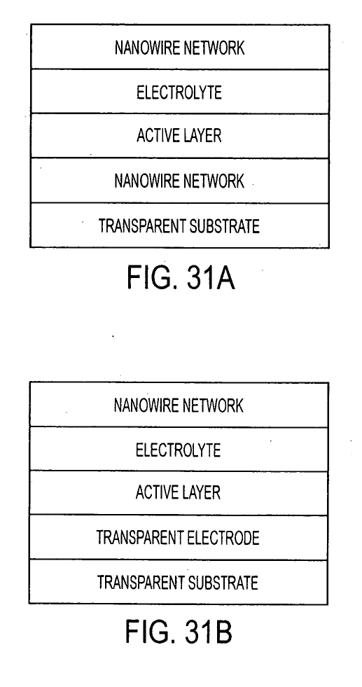

1. Smart Windows
A schematic representation of the structure of a smart window is shown in FIG. 31.

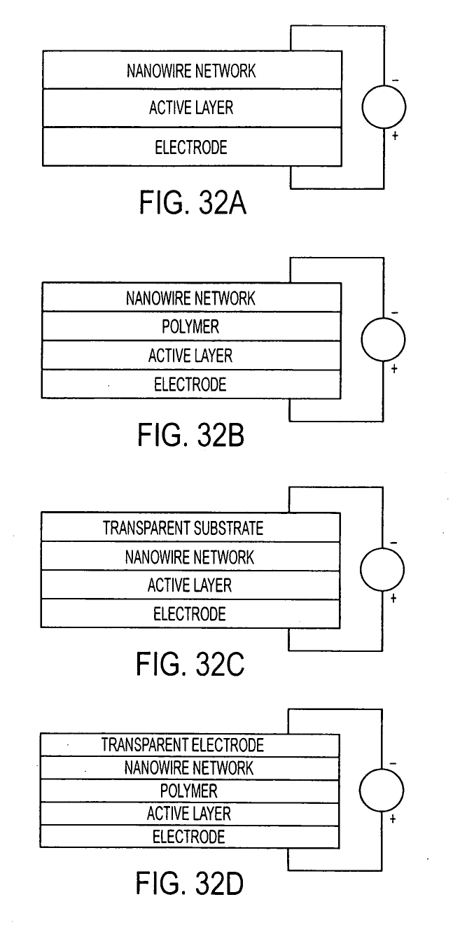

2. Solar Cell
A schematic representation of the structure of a solar cell is shown in FIG. 32. An embodiment is also described in this specification above.

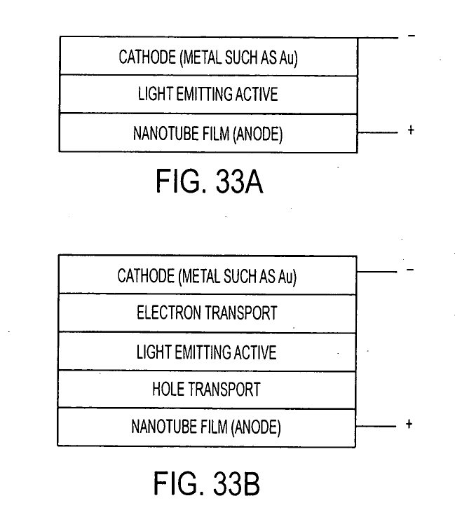

3. Light Emitting Diode
A schematic representation of the structure of a light emitting diode is shown in FIG. 33.

Embodiments of this invention also include, but are not limited to, multiple nanoscale networks with at least a carbon nanotube network. An example is also described above in the current specification.

4. Fuel Cell
See also the previously described “Carbon nanotube-sol-gel prepared nanostructured silica networks” herein.

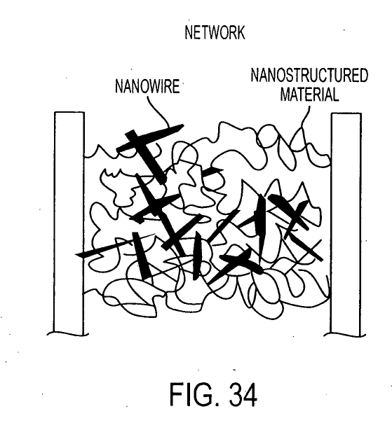

5. Nanotube on a Fabric
A schematic representation of the structure of nanostructures on a fabric is shown in FIG. 34, where the nanostructured material is a fabric. An example is also described above in the current specification.

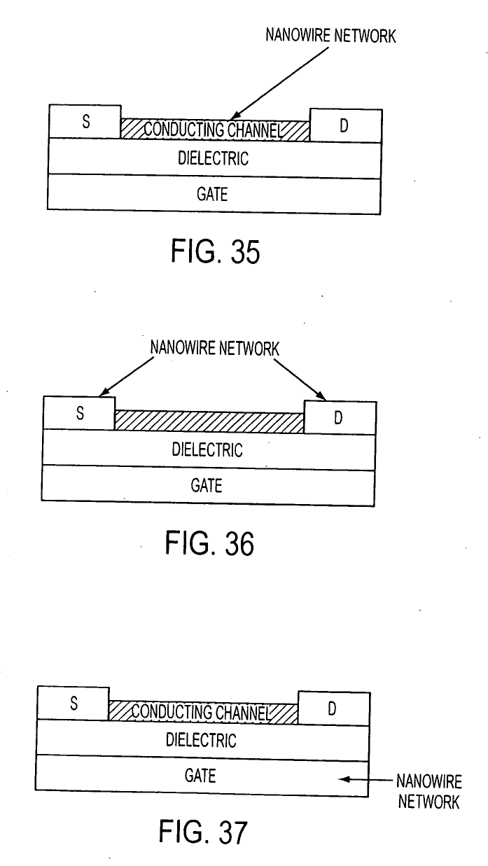

6. A schematic representation of the structure of a transistor is shown in FIGS. 35-37 with a nanoparticle network as part of the structure. Transistors where the network is the conducting channel has been patented before, with G. Gruner as one of the co-inventors.

Carbon Nanotube Network Electrodes Applications for Smart Windows

According to this embodiment of the current invention, a multilayer device architecture, that includes several nanoscale networks, with different functionalities was fabricated. Two carbon nanotube (NT) networks act as transparent electrodes with a polyaniline (PANI) layer serving as an electrochromatic layer. The architecture also includes an electrolyte layer. A change of the transparency, induced by a voltage applied between the NT electrodes, was observed. Potential applications include a variety of electrochromatic devices, such as glazing “smart” windows or electronic papers.

Transparent electrodes have been widely used in many technology areas, such as solar cells, light emitting diodes or electrochromatic devices, where light and electricity are coupled. Among them, transparent and conducting oxides (TCOs) are widely studied such as Al-doped ZnO, F-doped In₂O₃, SnO₂ and ZnO, which are all n-type electrodes. The most widely used TCO in optoelectronic devices is ITO (Indium Tin Oxide) since it offers the best performance in terms of the conductivity and transmissivity. The manufacture of commercial quantities of ITO on glass and roll-to-roll coating on optical grade polymers has become routine in the past using the dc-sputtering technique. ITO films on glass show high conductivity, which is the reason that ITO is widely used in flat-panel display and thin film solar cells. However, deposition of ITO on flexible polymer substrates requires low substrate temperature and high deposition rates, which substantially reduce the quality of ITO. For example, typical conductivities for ITO on PET are no better than 1000-1500 S/cm, about five times lower than ITO on glass. The fatigue tests also show that ITO films develop cracks at about 6000-cycle bending. The ITO on PET is also not environmentally resistant, for example it is not resistant to mild acid. Furthermore, the price of ITO has been rocketing recently due to the rarity of Indium on earth and the decrease of mining around the world. The price of ITO increased ten-fold over the past two years and this uptrend is believed to be continuing. At the same time, the demand for transparent electrical conductors, especially on flexible substrates, has been growing recently, especially due to the progress in large area display technology and solar cell applications. There is thus an urgent need for a replacement for ITO for various applications.

Single walled carbon nanotubes (SWNT) have caught much attention due to the quasi-one dimensional properties. Single walled carbon nanotubes have shown high conductivity up to 10⁶ S/cm and high current-carrying capacity up to 10⁹ A/cm².

Transparent and conducting films made of randomly distributed SWNTs have been studied by many groups. However, the conventional nanotube films on substrates either involve complicated and uncontrollable transfer processes, or the films could not be deposited in a patterned fashion.

Meanwhile, the development of electrochromatic (EC) devices based on conjugated conducting polymers has been actively pursued in recent years for smart windows and electronic paper applications due to the easy color tuning properties, short response time and high contrast. Polyaniline (PANI) is a typical example, which shows multiple colored forms depending on the oxidation state of the polymer film which include bright yellow, green and dark blue and shows promising properties for the next generation EC materials. In all of the major applications of the EC devices, highly transparent and conducting electrodes are needed, which are inexpensive, resistant to extreme environments, flexible, and are able to be patterned. Transparent and conducting SWNT films on PET substrates have been demonstrated as a replacement of ITO for electrochromatic device applications according to an embodiment of this invention. The PANI was electrochemically deposited on the SWNT films, and the liquid electrolyte was sandwiched between two transparent SWNT films.

The nanotube film preparation and the PDMS based stamping process described above according to an embodiment of this invention can be used for this embodiment. In this embodiment, laser ablation single walled carbon nanotube powder is refluxed with 2M HNO3 acid for 48 hours. Then the SWNT left over from the filtration of solution is dissolved in water with 1% Sodium dodecyl sulphate (SDS), isonicated for half an hour, centrifuged for 1 hour and filtrated through a 0.1 um pore size filter, followed by copious of water rinsing. The dried films are transferred onto other receiving substrates using a PDMS stamp. Transferred NT films with different thicknesses on PET are used as electrodes for electrochemical deposition of PANI. The thickness of the NT films and the transparency are related by the following equation

$$T = {( 1 + \frac{1}{2 {R}_{s}} \sqrt{\frac{{μ}_{0}}{{ɛ}_{0}}} \frac{{σ}_{op}}{{σ}_{dc}} )}^{- 2} = {( 1 + \frac{188 ( Ω )}{{R}_{s}} \frac{{σ}_{op}}{{σ}_{dc}} )}^{- 2}$$

where sheet resistance Rₛ equal to 1/σ_{dc}t and t is the thickness, σₒₚ˜200 S/cm, σ_{dc}=1600-2000 S/cm

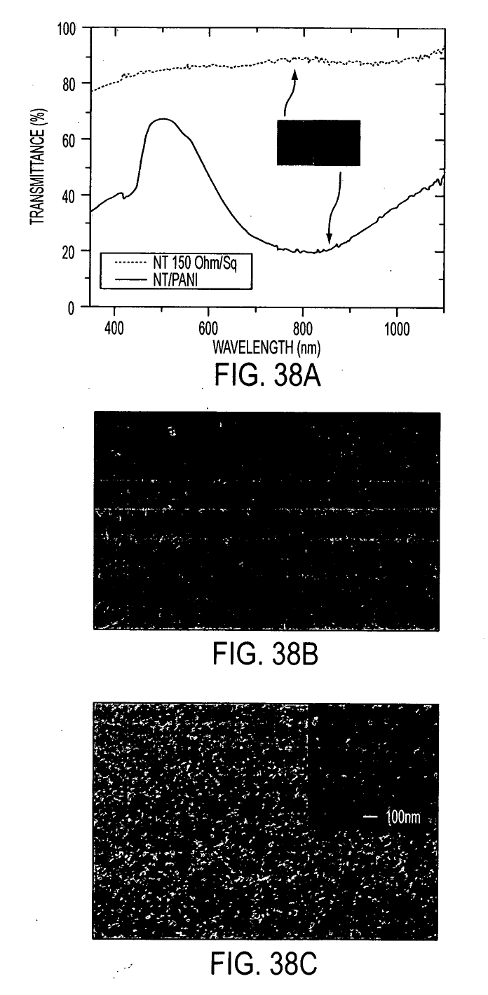

For the deposition, we used an electrochemical setup using 0.1 mM aniline solution with a reference electrode. Nanotube films with sheet resistance equal 150 ohm/sq on PET for the electrochemical deposition were used. The counter electrode is Pt. The applied voltage is fixed at constant voltage with 0.8V and the PANI growth time is 5 minutes. During the PANI growth, only the bottom half of the NT films is dipped into the aniline solution and the top half is exposed in air. The end of the top part is connected to a copper wire by silver paint. FIG. 38(A) shows the transparency measurement of NT films before and after the 5 mins PANI growth, which is measured by taking into account the PET substrates. The thickness of NF film is around 30 nm. The insets show the photograph of the NT films with coated PANI films. The left side is for the NT exposed in air and the right side is for the NT dipped in the aniline solution during the electrochemical growth. The dark blue in FIG. 38(B) is the PANI coated NT. The uniform color in the large area indicates the uniformity of and the high conductivity the NT films. The NT films are examined by SEM images using JOEL before and after the electrochemical deposition of PANI. FIG. 38(B) shows the 30 nm thick transferred NT films, which are clean and uniform. There is no PDMS leftover in the transferred NT films. One could also see that the trace of the NT films which is compressed which is due to the soft mechanical pressure applied during the transfer process. FIG. 38(C) shows the PANI grown on the top of NT films. The grown PANI films are uniform as well. By zooming in the PANI films, the deposited PANI films show island structure, which may due to the porous surface of NT films.

FIG. 38(A) shows Transmittance vs wavelength for 150 Ohm/Sq NT films before and after the PANI coating for 5 minutes at 0.8 fixed voltage. Insets: the left side is for the NT exposed in air and the right side is for NT dipped into the aniline solution. FIG. 38(B) shows SEM of the transferred NT film with 30 nm thickness on PET substrate and FIG. 38(C) shows SEM of PANI coated on top of NT film.

The growth rate of PANI depends on the thickness of SWNT films. The thicker the NT film, the quicker the electrochemical growth of PANI, which is indicated by the deeper color of the PANI. But even for ultrathin SWNT films such as monolayer (˜1 nm thick), clear blues color was observed after longer deposition time.

One can use electrochemical coating such that the PANI can be uniformally coated on the SWNT films.

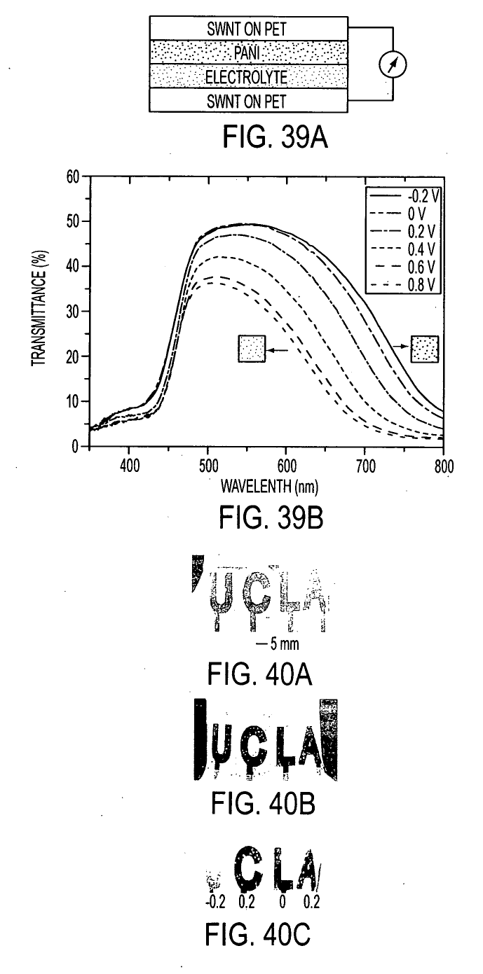

PANI has multiple colored forms depending on the oxidation state of the polymer which include leucoemeraldine (bright yellow), emeraldine (green) and pernigraniline (dark blue). An electrochromatic device (ECD) using electrochemically deposited PANI on NT films is assembled as shown by the schematic in FIG. 39(A). One NT film with 80% transparency at 550 nm and 150 Ohm/Sq transferred on PET is used as the electrode for electrochemical deposition of PANI for 5 minutes at 0.8V, and another same NT film is used as the opposite electrode. Sandwiched between the PANI coated NT film and the other NT film is the electrolyte, and in this case, is 0.1M H₂SO₄, which is not limited to this type of electrolyte. The reasons we choose acidic and liquid electrolyte are, firstly, liquid electrolyte is good enough to study the EC effects of PANI coated on SWNT film, compared to the solid electrolyte candidate, and, secondly, the ITO on flexible substrate such as PET does not survive in acidic environment, which SWNT on PET is resistant acid, which is an advantage of SWNT compared to ITO on flexible substrates.

FIG. 39(B) shows the voltage dependence transparency of the whole device from −0.2V to 0.8. The color changes from light blue to dark green, which is due to the different oxidation states of PANI under different applied voltages. The color is uniform in a large area up to 2 cm by 2 cm, which indicates the transferred SWNT films are uniform and highly conducting since the SWNT film and PANI coated SWNT films are connected to copper wire at the ends of the films where voltages are applied. We also employed single wavelength spectrophotometry to study the switching time between different oxidation states by monitoring the transmittance at three fixed individual wavelength 400, 550 and 700, which gives 10 seconds. After one week, the device is re-measured, and the characteristics do not change, which indicate that the SWNT film is sufficiently acid resistant.

Due to the tremendous need for transparent conductors, a lot of researches has been done to find new candidates as the replacement for ITO for various device applications. Among them, conducting polymers, for example PEDOT/PSS has caught much attention due to the easy processing steps. As far as EC devices are concerned, Avini make the first true all-polymer EC devices using PEDOT/PSS as the replacement of ITO. In their letter, 600 Ohm/Sq with ≧5% transparency at 550 nm have been reached. Here NT films with 160 Ohm/Sq with ˜80% at 550 nm has been reached, which is at least 4 times better than PEDOT/PSS electrodes. This is the first time that the transferred NT film has been used for the replacement of ITO for device applications. Transparent conducting NT films, as a hole-electrode, meet all the requirements of ITO for further applications, especially on flexible substrates, in terms of the transparency/sheet resistance (typical data 150 Ohm/Sq with 80% transparency on PET), and the work function concerned (˜4.7 eV). The porous structure of NT electrodes may have other advantages over the traditional flat alternatives.

FIG. 39(A) is a schematic representation of the EC device by sandwiching electrolyte between 80% transparency and 150 Ohm/Sq NT films and PANI coated same NT film and FIG. 39(B) shows the whole transparency of CE device under different applied voltages.

We also patterned NT films by simply patterning the PDMS stamps before the transfer process. FIG. 40(A) shows the transferred NT films on PET. The highest resolution of the patterned NT films is around 10 um, which is limited by the spun SU-8 thickness and photolithography steps. Then, the PANI is electrochemically deposited on the “UCLA” NT films using the same condition as before, as shown in FIG. 40(B). The PANI films are only deposited along the “UCLA” pattern and are uniform from the color, which are due to the high conductivity of the NT films.

FIG. 40(C) shows the PANI coated NT films under different applied voltages for different parts, −0.2V, 0V and 0.2V. Also it can be bent for large angle without damaging the quality of the NT and PANI films, as show in FIG. 40(C) as well. The flexibility, ease of patterning and environmental resistance makes the transferred NT films on flexible substrates useful for EC device applications, such as electronic paper and flexible smart windows.

FIG. 40(A) shows the transferred NT film on PET in a patterned fashion, where “UCLA” are the lines of the NT films. The horizontal length is around 4 cm.

FIG. 40(B) corresponds to after PANI electrochemical deposition after 5 minutes, and FIG. 40(C) is for the cases under different applied voltages and bending.

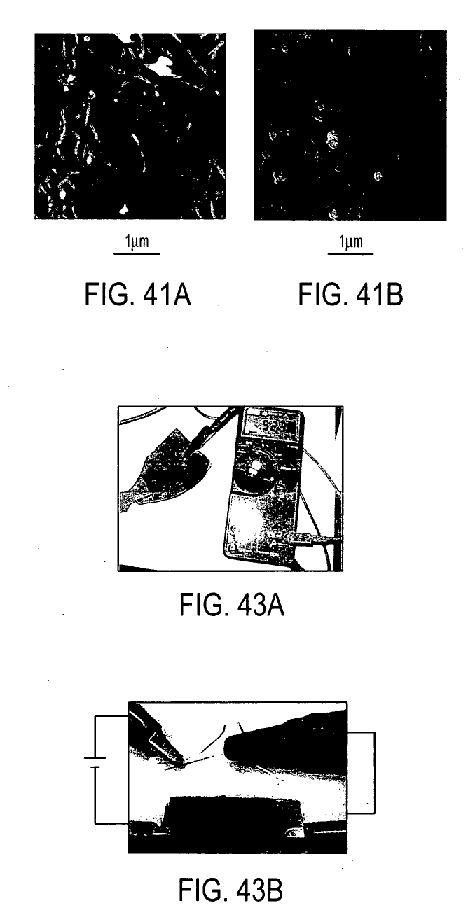

Furthermore, it is shown that PANI could be electrochemically deposited onto even sub-monolayer NF films. FIG. 41(A) shows the AFM images NT films and FIG. 41(B) shows NT with PANI after 2 minutes of deposition. Even for submonolayer NT films, the PANI is still covered after 5 mins electrochemical deposition. For 2 minutes of deposition, the NF are coated only on the top of nanotubes. This is the first time that the PANI has been electrochemically deposited on the solution based nanotubes. Phorous A et al. have shown that the doping states change the poraity of the transistor. By this type of electrochemical deposition of PANI on NT could eventually useful to do further study of this type of system. Also polymer coating nanotube has been shown to decrease the hysteresis of transistors by removing the mobile ions. The uniformly coated PANI, by electrochemical deposition, could be an effective method to coat NTs, which make the functionalization of nanotube by polymers easy to control.

FIG. 41(A) shows AFM of transferred NT films on SiO₂ with 50 k Ohm/Sq sheet resistance and FIG. 41(B) shows AFM of 2 minutes electrochemical deposition PANI on the NT films

In concluding this example of an application of the current invention, the transferred single walled carbon nanotube films on flexible PET have been used for electrodes for PANI electrochemical deposition, which could be applied to any conducting polymer. The uniformity of the deposited PANI on top of the NT films indicates the continuity and the high conductivity of the NT films. The transferred transparent NT films are used as a replacement of ITO for EC device applications. The EC devices using PANI as the color change materials and the NT films as the transparent electrodes were demonstrated herein. Furthermore, selective color change and the flexibility of the device has been demonstrated, which can be used for smart windows and electronic paper applications. Even for sub-monolayer NT films, the electrochemical deposition of the PANI is successful and the PANI is found to wrap around the NTs and grows along the NTs, which may be useful to study the charge transfer between PANI and NT under PANI different oxidation states.

Experiment:

For making the “UCLA” patterns, silicon substrates are used as the master for PDMS stamps. For patterned masters, the silicon substrate is baked for 15 minutes at 150° C., and SU-8 photo resist is spun onto the silicon wafer for 30 seconds at 4000 rpm, which gives a 20 um thick resist layer. This is followed by a soft bake at 65° C. for 3 minutes and 90° C. for 4 minutes. Then it is exposed with 405 nm light for 75 seconds at a power of 8 mW/cm². The post-exposure baking procedure is the same as the soft bake. After 5 minutes development using SU-8 developer, the sample is rinsed by IPA and blow dried. In the end, the master is treated with 2 hours silanization in the vapor of (Tridecafluoro-1,1,2,2-tetrahydrooctyl)-1-trichlorosilane. Other transfer details for making “UCLA” NT films on PET are in our previous work.

The following reference may be useful as background related to the current example and are incorporated herein by reference:
Mat. Res. Soc. Symp. Proc. Vol. 668, 2001 Material Research Society “The twists of carbon nanotubes”, Oe magazine, Apr. 25, 2005 “Indium price soars as demand for displays continues to grow”, compound semiconductor.net, May, 2005
. Yao, C. L. Kane, C. Dekker, Phys. Rev. Lett. 2000, 84, 2941.
Z. C. Wu, Z. H. Chen, X. Du, J. M. Logan, J. Sippel, M. Nikolou, K. Kamaras, J. R. Reynolds, D. B. Tanner, A. F. Herbard, and A. G. Rinzler, Science 305, 1273 (2004).
L. B. Hu, D. S. Hecht and G. Gruner, Nano Lett. 4, 2513 (2004).
N. Sarah, K. Parikh, D. S. Suh, E. Munoz, H. Kolla, and S. K. Manohar, J. Am. Chem. Soc. 126, 4462 (2004).
Meitl, M.; Zhou, Y.; Gaur, A.; Jeon, S.; Usrey, M.; Strano, M.; Rogers, J. Nano Lett.; 2004; 4, 1643
M. Kaempgen, G. S. Duesberg and S. Roth, Appl. Surf Sci. 252, 425 (2005).
Elena Bekyarova, Mikhail E. Itkis, Nelson Cabrera, Bin Zhao, Aiping Yu, Junbo Gao, and Robert C. Haddon, J. AM. CHEM. SOC. 2005, 127, 5990-5995
Kim, Y.; Minami, N.; Zhu, W.; Kazaoui, S.; Azumi, R.; Matsumoto, M. Jpn. J. Appl. Phys. 2003, 42, 7629
K. Bradley, J-C P Gabriel and G. Gruner, “Flexible Nanotube Electronics”, Nano Lett 3, 1353-1355
Y. Zhou, L, Hu, And G. Gruner submitted to APL
Mortimer, R. J. Electrochim. Acta 1999, 44, 2971 Lacroix, J. C.; Kanazawa, K. K.; Diaz, A. J. Electrochem. Soc. 1989, 136, 1308
Ching, J.-C; MacDiamid, A. G. Synth. Met. 1986, 13, 193
Keith Bradley, John Cumings, Alexander Star, Jean-Christophe P. Gabriel, and George Grüner, Nano Lett. 3, 639-641 (2003)
Christian Klinke,* Jia Chen,* Ali Afzali, and Phaedon Avouris NANO LETTERS 2005 Vol. 5, No. 3, 555-558
   Organic Light Emitting Diode
   1. Device Fabrication

SWNT powders are suspended in water with the surfactant SDS followed by sonication and filtering. Washing with de-ionized water is used to remove the SDS. A PDMS-based transfer method is then applied to transfer the nanotube films onto PET substrates. Other layers were deposited using the methods described in Huang, Q.; Evmenenko, G. A.; Dutta, P.; Lee, P.; Armstrong, N. R.; Marks, T. J. J. Am. Chem. Soc. 2005, 127, 10227; Yan, H.; Scott, B.; Huang, Q.; Marks, T. J. Adv. Mater. 2004, 16, 1948; and Yan, H.; Lee, P.; Armstrong, N. R.; Graham, A.; Evmenenko, G. A.; Dutta, P.; Marks, T. J. J. Am. Chem. Soc. 2005, 127, 3172. A polymer blend hole transporting layer (HTL) composed of a cross-linkable, hole-transporting organosiloxane material such as TPD-Si₂ and a hole-transporting polymer such as TFB, which also serves as an effective PLED electron-blocking layer, was spin-coated onto the clean carbon SWNT film or onto a PEDOT-PSS-coated carbon SWNT film to form a double-layer HTL. These HTL films were then baked in a vacuum oven at ˜90° C. for 1-2 h. The PEDOT-PSS had been spin-coated onto the SWNT sheet at 2500 rpm for 1 min, followed by drying at 120° C. for 8 min. Next, a well-balanced charge transport/emissive layer (EML), a TFB+BT blend (TFB:BT=1:4) was spin-coated onto the HTL-coated substrates from xylene solution, resulting in an EML thickness of 70 nm. The resulting films were dried in a vacuum oven at ˜90° C. overnight. Inside an inert-atmosphere glove box, CsF and then Al was thermally evaporated onto the EML in a vacuum of <10⁻⁶ Torr using a shadow mask to define the 2 mm×5 mm electrode area.

2. Characterization

The PLED devices were characterized inside a sealed under a dry N₂ atmosphere using a source meter and a Radiometer.

The PLED with PEDOT-PSS and TFB+TPD-Si₂ as a double-layer HTL shows a low turn-on voltage of 4.1 V, a maximum luminance of 500 cd/m², and a maximum current efficiency of 0.6 cd/A. The device exhibits more than a 2-fold increase of maximum luminance, ˜50%, lower turn-on voltage, greater current density and current efficiency than the device having TFB+TPD-Si₂ only as the HTL.

Electronic Properties of Carbon Nanotube/Fabric Composites

Single walled carbon nanotube (SWNT)/fabric composite materials were manufactured using two manufacturing processes according to embodiments of the current invention. The first method is direct deposition of SWNTs by either a spray method or by incubation; the other is a Quasi-Langmuir-Blodgett (QLB) transfer technique. The composite retains high mechanical strength (governed by the fabric), and good electrical properties (determined by the nanotubes). We measure the DC electrical conductivity of the composite fabric to be 5.33 S/cm for the sprayed tubes, 13.8 S/cm for the incubated SWNTs, and 8 S/cm for the QLB transferred tubes. These values are limited not by the nanotube network, but by the surface roughness of the fabric itself. Measurements of the conductivity up to one MHz reveal a transport process that proceeds along a random network, with barriers separating the various nanotubes. The material is resistive both to changes in temperature (range of 0-80 degrees Celsius) and mechanical deformations. The conductivity of the composite decreases by less than 10% when bent around a cylinder of 1 cm diameter.

Networks of carbon nanotubes are emerging as a material that is relevant from both a scientific and an applications viewpoint, both in stand alone applications or when combined with other materials. Nanotube-polymer composites, for example, have been thoroughly explored (P. M. Ajayan, L. S. Schadler, C. Giannaris, A. Rubio, Adv. Mater. 12 (2000) 750; B. Safadi, R. Andrews, E. A. Grulke, J. Appl. Polym. Sci. 84 (2002) 2660), with embedded nanotubes enhancing the mechanical and electronic properties of the polymer matrix. Two dimensional networks of conducting nano-scale wires such as carbon nanotubes have been fabricated before on a variety of smooth surfaces, such as glass, polymers, and inorganic oxides. Such networks show two dimensional (2D) percolation features, and evidences of a transport process that proceeds through thermally activated charge hopping between the various nanotube segments.

In this application of an embodiment of the current invention, we describe the fabrication and examination of the conducting properties of carbon nanotube networks on a “rough” surface, exemplified by a non-conducting fabric. This composite material has—aside from the interest as a model system for diffusive charge transport along two interpenetrating networks—significant application potential. Lightweight, conducting, wearable fabric can and will be used for microwave absorption, static charge dissipation, resistive and microwave heating, Electromagnetic Interference (EMI) Shielding, and—in its patterned form—wearable antennas, and interconnects. Functionalized carbon nanotubes have been shown to operate as extremely sensitive sensors for the selective detection of both gases and biomolecules. These sensors will in the future be incorporated as wearable sensors that can be fabricated directly onto various fabrics.

Experimental

To fabricate our conducting fabric material, we used two major coating strategies: direct deposition through spaying/incubation, and the QLB thin film deposition technique (first demonstrated by Armitage et. al.). In both cases, we used purified arc SWNTs (P2) bought from Carbon Solutions, with no additional purification steps. Both methods involve the application of a well dispersed solution of SWNTs to a fabric surface. To make this solution, we use 0.2-0.5 mg/ml of nanotubes in an aqueous solution of 1% sodium dodecyl sulfate (SDS). This solution is mixed by high powered sonication from a probe sonicator for 1 hour and 40 Watts to form a surfactant stabilized suspension. These suspensions are stable for time periods on the order of months with no visible tube flocculation.

One method for direct deposition of the nanotubes in solution onto almost any surface is through a spraying technique, where a dilute (0.01-0.02 mg/ml) solution of well dispersed nanotubes is sprayed through a fine mist onto the substrate of interest. The nanotubes are sprayed onto the fabric surface using a Paasche airbrush, with the fabric heated to 100° Celsius to avoid forming large droplets and small pools of liquid, which would decrease the film uniformity. The fabric is then soaked in water for 10 minutes to remove residual SDS. One can also perform a simple incubation and soak the fabric in the nanotube solution directly, under gentle stirring, followed by a water rinsing. Another method used to coat the fabric is the QLB technique, which involves first vacuum filtering the solution of carbon nanotubes in SDS through a porous alumina filter (Whatman, 20 nm pore size), followed by the re-deposition of the film by flowing water over the filter and allowing the film to break free and float on the water's surface, where it can be re-deposited onto the fabric substrate.

All resistance measurements were made using a two probe measurement with a Keithley 2400. Frequency dependent conductivity measurements up to 1 MHz were made using an Agilent 4284A LCR meter. SEM imaging was performed using a Hitachi S4700 Field Emission SEM with 1.5 kV and 5 uA emission current.

Results and Discussion

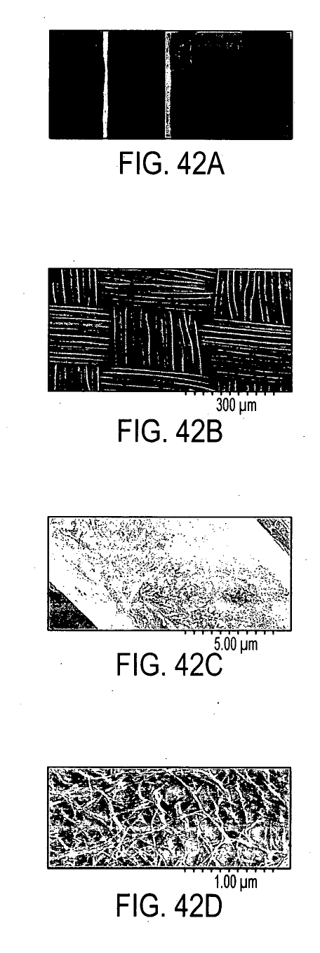

The spray deposition technique is a simple and cheap method for coating a fabric surface with nanotubes. It can make patterns down to the resolution of the spray mist, can be easily scaled up for large area applications, and can be used on almost any surface compatible with water. The results are films of controllable sheet resistance and, for films that are relatively thin, films that retain high transparency. FIG. 42A shows the fabric with a square shaped region in the middle sprayed with nanotubes (far right, darker square in the middle of the fabric has been sprayed), and FIG. 42B/C/D shows SEM images of the sprayed fabric at increasing magnification. The optical image of the sprayed, conductive fabric shows the camouflage pattern showing through the mostly transparent nanotube layer. Nanotube films can be transparent, as well as conductive. For our hand-held sprayer, the films are not perfectly uniform (film uniformity defined as the variation in nanotube density (NT/Area) over the surface of the fabric). The nanotube density can be determined directly from SEM images, as well as indirectly from measurements of the sheet resistance at various locations of the fabric, since the sheet resistance should be proportional to the network density when well above the percolation threshold. The film shown in FIG. 42A has a sheet resistance of 75 kΩ/square±10 kΩ/square over the area of the fabric surface sprayed (we used a piece of fabric about 5 cm by 5 cm which can be scaled up for applications). The uniformity of the films will be determined by the droplet size in the spray mist, as well as the spatial distribution of droplets in the mist. These two parameters can be controlled in industrial applications to make films of extremely high uniformity. The nanotube density can be finely controlled by adjusting both the volume of liquid sprayed onto the fabric, and the initial concentration of nanotubes in the aqueous solution.

A simple incubation technique where fabric is soaked in nanotube solution for varying amounts of time under gentle stirring yields fabric that has a higher conductivity than with the spray technique, and has mostly uniform distribution of tubes, but leaves some dark patches where the tubes stick very well to the fabric. FIG. 42A shows a piece of fabric with no nanotubes (far left) and after incubation overnight (middle). The sheet resistance for this fabric is 29 kΩ/square average where there is a monolayer coverage, with some more dense (thicker) patches of tubes down to 5-10 kΩ/square that appear visibly darker.

FIG. 42 shows optical (A) and SEM (B, C, D) images of the sprayed nanotube fabric. The optical photograph shows from left to right: fabric with no nanotubes, fabric with an incubated layer of 29 kΩ/square, and fabric with a square shaped sprayed area of nanotubes (darker region in middle) yielding about 75 kΩ/square. The SEM image in FIG. 42(B) shows fabric fiber morphology. FIG. 42(C) shows the tubes coating one of the fibers. The distribution of nanotubes along each fiber in the bundle is non-uniform, but about one monolayer. FIG. 42(D) shows an image zoomed in on one fiber, revealing nanotube bundle sizes between 20-30 nm in diameter and 0.5-2 um long.

By controlling the density, one can control the sheet resistance (R) of the sample. Using the thickness (t) of our nanotube layer, coupled with the measured sheet resistance, one can calculate the DC conductivity of the sample, by using the equation
σ_{DC}=1/(R*t).
Using a sheet resistance of 29 kΩ/sq for the incubated fabric and 75 kΩ/sq for the sprayed fabric, and assuming about a one monolayer thick network (with a nanotube bundle size of 25 nm), we calculate a conductivity of 13.8 S/cm for the incubated nanotube films on the fabric and 5.33 S/cm for the sprayed films. It has been shown in previous work that two-dimensional nanotube films sprayed onto a flat surface (quartz or plastic) have a conductivity of 150-200 S/cm, which is over one order of magnitude higher than for our films on fabric. The reason for this discrepancy is most likely due to the roughness and curvature of the fabric surface causing poor contact between the SWNTs on separate threads within the fabric. The trend that incubated fabrics have higher conductivity than the sprayed fabric is understandable as the incubation technique allows more intimate contact between the nanotubes in solution and the threads in the fabric, while the spray technique may have some threads masking those beneath them in the weave pattern, thus causing gaps in the nanotube coating. One can use the fabric in simple circuits as shown in FIG. 43, where a battery is hooked in series with an LED and a piece of fabric, which acts as a simple wire or interconnect. Application of a voltage across the fabric circuit causes the LED to light.

In particular, FIG. 43 shows conducting fabric can be used as interconnects along a piece of clothing. Here, FIG. 43(A) shows the measurement of the resistance of a thin layer of nanotubes sprayed onto the fabric and FIG. 43(B) shows a circuit set up to light an LED with a battery, using a piece of fabric as a simple wire in series with the battery and LED.

The second method for nanotube network film deposition involves the re-deposition of a nanotube network from the surface of an alumina filter to the fabric surface. We can make nanotube network films with a conductivity of 1600 S/cm, using a vacuum filtration method to deposit tubes on an alumina filter. However, when we re-deposit the film from the filter to the fabric surface using the QLB technique, we measure the conductivity of the film to be about 8 S/cm, which is a decrease in conductivity by a factor of 200. That is to say, the conductivity, of the same exact SWNT network, is more than two orders of magnitude worse on the rough surface of the fabric, than on the smooth surface of the filter. The morphology of the fabric surface makes a significant difference in the film conductivity; discontinuities, crossing threads, and gaps in the fabric itself leads to a dramatic increase in resistance over the nanotube network film on a smooth surface.

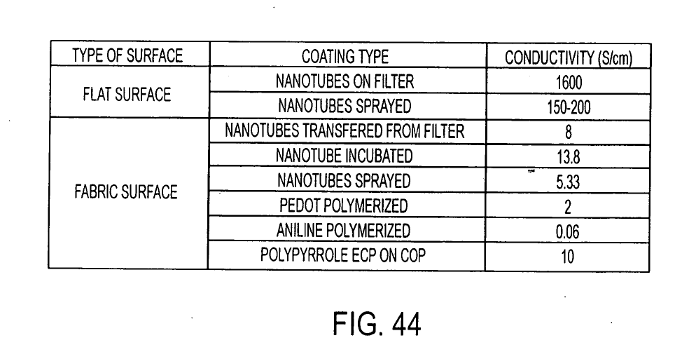

Previous studies of conducting fabric have been done using PEDOT and aniline polymerized on nylon 6 fabric which yielded maximum conductivities of 2 S/cm and 0.06 S/cm, respectively. Fabric coated with polypyrrole by Electrochemical Polymerization yielded conductivity up to 10 S/cm. The nanotube network/fabric composites presented in this section have competitive conductivities, as shown in the table of FIG. 44. Nanotube networks are also stable in air and practically insoluble in water once deposited on the fabric. Conducting polymers like polypyrrole are also insoluble in water and concentrated-acid, and air stable, but are degraded by oxidants and alkaline solutions. Carbon nanotubes are robust under most weather conditions, and show very little change in conductivity in temperature ranges from −20° C. to 80° C. Almost no change of the conductivity of the network was found under repetitive bending of the fabric, indicating that the nanotube network is resistive to mechanical distortions. The conductivity of the network decreases by less than 10 percent when the fabric is wrapped around a cylinder that has a 1 cm diameter.

The table of FIG. 44 shows conductivities of various materials on both flat (filter/PET) and rough (fabric) surfaces.

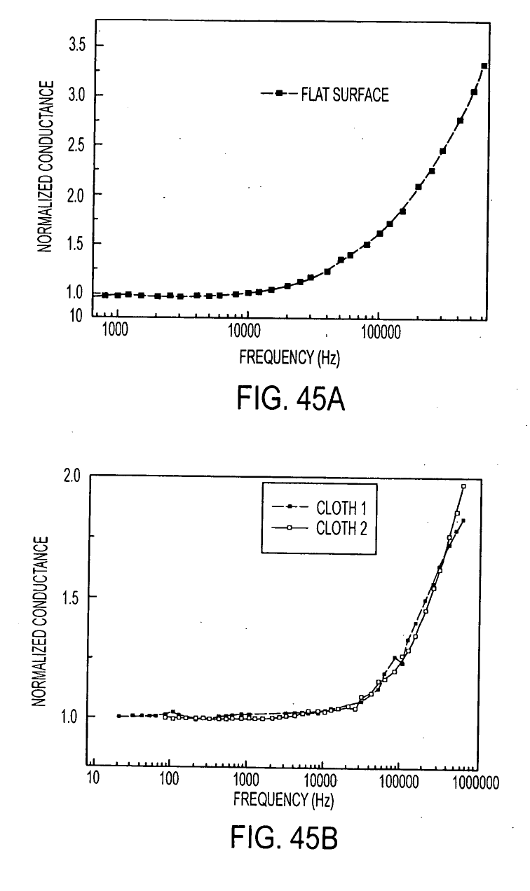

The overall frequency dependence of the DC conductivity of the nanotube network on the fabric surface is similar to that observed on nanotube networks on flat surfaces. FIG. 45 shows the frequency dependence of the normalized conductance out to 1 MHz for both a flat (filter) and rough (fabric) surface. The increasing conductance with increasing frequency gives evidence of a transport process that proceeds along a random network with barriers separating the various nanotubes.

In particular, FIG. 45 shows the frequency dependence of the conductivity.

The increasing conductivity with increasing frequency gives evidence of a transport process that proceeds via hopping over (random) barriers. In our system, the tube-tube interconnect provides a random barrier height for electron transport.

### CONCLUSION

We have fabricated a carbon nanotube network on a rough surface: a fabric. The network has excellent mechanical (determined by the fabric) and electrical properties (determined by the nanotube network), indicating its significant application potential, when combined with wearable photovoltaic or active electronic devices.

The properties of the coated fabric are comparable to conducting polymer coated fabrics. We expect that significant improvement can be made by inter-dispersing the network during fabric production into the fabric matrix itself, creating a more dense—and maybe a three dimensional—network, instead of the two dimensional network that resides on the surface of the fabric. This should significantly aid the conductivity as the limiting factor at this point seems to be topological gaps in the fabric between threads. Also, one can optimize the choice of fabric towards one with a flatter surface. In addition, the network can be modified towards a specific purpose. For example, recognition molecules that are sensitive to different analytes can be attached to the carbon nanotubes themselves to make wearable chemical and biological sensors.

The following references provide background information that may be relevant to this section and are incorporated herein by reference.
1. P. M. Ajayan, L. S. Schadler, C. Giannaris, A. Rubio, Adv. Mater. 12 (2000) 750.
2. B. Safadi, R. Andrews, E. A. Grulke, J. Appl. Polym. Sci. 84 (2002) 2660.
3. N. P. Armitage, J. Gabriel, G. Grüner, J. Appl. Phys. 95 (2004) 3228.
4. E. Artukovic, M. Kaempgen, D. S. Hecht, S. Roth, G. Grüner, Nano Lett. 5 (2005) 757.
5. L. Hu, D. S. Hecht, G. Grüner, Nano Lett. 4 (2004) 2513.
6. A. Kaiser, K. Challis, G. McIntosh, G. Kim, H. Yu, J. Park, S. Jhang, Y. Park, Curr. App. Phys. (2002) 163.
7. A. Kaiser, G. Düsberg, S. Roth, Phys. Rev. B 57 (1998) 1418.
8. Y. Wang, X. Jing. Polym, Adv. Tech. 16 (2005) 344.
9. H. M. Kim, K. Kim, C. Lee, J. Joo, S. Cho, Appl. Phys. Lett. 84 (2002) 589.
10. P. Qi, O. Vermesh, M. Grecu, A. Javey, Q. Wang, H. Dai, Nano Lett. 3 (2003) 347.
11. A. Star, J. Gabriel, K. Bradley, G. Grüner, Nano Lett. 3 (2003) 459.
12. M. Kaempgen, G. A. Duesberg, S. Roth, Appl. Surf. Sci. 252 (2005) 425.
13. Y. Zhou, L. Hu, G. Grüner, Submitted to Nano Lett.
14. K. Hong, K. Oh, T. Kang, J. Appl. Polym. Sci. 97 (2005) 1326.
15. K. Oh, K. Hong, S. Kim, J. Appl. Polym. Sci. 74 (1999) 2094.
16. S. Kim, S. Jang, S. Byun, J. Lee, J. Joo, S. Jeong, M. Park, J. Appl. Polym. Sci. 87 (2003) 1969.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. An electronic or electro-optical device, comprising:
a substrate;
a nanostructured network supported by said substrate; and
at least one of a functional layer of material supported by said substrate and an encapsulating layer disposed over said nanostructured network,
wherein said nanostructured network is constructed to have an electrical conduction above a percolation threshold through said nanostructured network.

33. An electronic or electro-optical device according to claim 32, wherein said functional layer is formed on said nanostructured network and said encapsulating layer is formed on the combined nanostructured network and functional layer to prevent functional material from being removed from said electronic or electro-optic device.

34. An electronic or electro-optical device according to claim 32, wherein said nanostructured network comprises an interpenetrating network of nanostructures.

35. An electronic or electro-optical device according to claim 34, wherein said interpenetrating network of nanostructures comprises a first network comprising a plurality of first nanostructures and a second network comprising a plurality of second nanostructures, said plurality of first nanostructures having a physical property different from a corresponding physical property of said plurality of second nanostructures.

36. An electronic or electro-optical device according to claim 34, wherein said interpenetrating network of nanostructures comprises a first network comprising a first type of nanostructures and a second network comprising a second type of nanostructures.

37. An electronic or electro-optical device according to claim 36, wherein at least one of said first and second types of nanostructures is selected from nanoparticles, nanowires, nanofibers, nanoribbons, nanoplates and nanotubes.

38. An electronic or electro-optical device according to claim 36, wherein at least one of said first and second types of nanostructures is selected from inorganic nanowires, polymeric nanofibers, carbon nanotubes, organic fibers, metallic nano-particles, biological materials, nanostructured light-sensitive materials and activated carbon.

39. An electronic or electro-optical device according to claim 32, wherein said functional material is selected from an organic compound, a polymer having an electron acceptor group, an inorganic species, and a light-sensitive material.

40. An electronic or electro-optical device according to claim 39, wherein said organic compound is at least one of TCNQ and TCNE.

41. An electronic or electro-optical device according to claim 39, wherein said polymer having an electron acceptor group is polyethylene imine.

42. An electronic or electro-optical device according to claim 39, wherein said inorganic species is at least one of Br, Cl, I, SOCl₂, SO₃, NO₂, NOBF₄, and NO₂BF₄.

43. An electronic or electro-optical device according to claim 39, wherein said light-sensitive material is porphyrine.

44. An electronic or electro-optical device according to claim 32, wherein said functional material is a polymer that prevents non-specific binding of biomolecules or sensitivity to serum.

45. An electronic or electro-optical device according to claim 32, wherein said encapsulating layer is at least one of a layer of a polymer and a layer of light-sensitive material.

46. An electronic or electro-optical device according to claim 32, wherein said encapsulating layer comprises at least one of parylene, PEDOT and PMPV.

47. An electronic or electro-optical device according to claim 32, wherein said electronic or electro-optic device is one of an electrical resistor, an electrical conductor, a diode, a transistor, a chemical sensor, a bio-sensor, and a photo-voltaic cell.
